(19) United States
(12) Patent Application Publication
(10) Pub. No.: US 2007/0024739 A1
(43) Pub. Date: Feb. 1, 2007

(54) Image pickup optical systems, image pickup apparatuses and digital apparatuses

(75) Inventor: Kenji Konno, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/492,741

(22) Filed: Jul. 25, 2006

(30) Foreign Application Priority Data
Jul. 26, 2005 (JP) 2005-216318

(51) Int. Cl. H04N 9/07

(52) U.S. Cl. 348/337

(57) ABSTRACT

The present invention provides image pickup optical systems capable of suppressing the degradation of the image quality due to unnecessary light beams while attaining compaction by optimizing the shapes of the emission surfaces of reflection prisms. The image pickup optical system includes an incidence-side prism for reflecting incident light while folding it by about 90 degree and an image-surface side prism. An image pickup device is placed near the emission surface of the image-surface side prism. The incidence-side prism is formed to have a convex emission surface. This can reduce the amount of the unnecessary light beams (stray light) reflected by the aforementioned reflection surface and also causes the unnecessary light beams reflected by the emission surface and the reflection surface to be diffused, thereby significantly reducing the amount of unnecessary light beams directed to the light receiving surface of the image pickup device. This can suppress the occurrence of ghosts and the like due to unnecessary light beams as aforementioned.

The present application claims priority to Japanese Patent Application No. 2005-216318 filed on Jul. 26, 2005, the entire contents of which are hereby incorporated by reference.

### BACKGROUND OF THE INVENTION

1. Field of the Invention

The present invention relates to image pickup optical systems, image pickup apparatuses and digital apparatuses incorporating the image pickup optical systems.

2. Description of the Related Art

In recent years, there has been prominently advanced the widespread use of digital still cameras, digital video cameras and digital apparatuses such as camera-equipped cellular phones and portable information terminals (PDAs: Personal Digital Assistants), and there have been steeply increased the numbers of pixels and the functions of the image pickup devices mounted on these apparatuses. Accordingly, there has been a need for image pickup optical systems with excellent optical performance for directing optical images of objects to such image pickup devices, in order to sufficiently utilize the performance of the image pickup devices having increased number of pixels.

Further, digital apparatuses as aforementioned are required to have excellent portability, and one possible means for reducing the sizes of such digital apparatuses is compacting the image pickup optical systems therein. Conventionally, for example, image pickup optical systems having retractable construction have been utilized as a means for compacting the image pickup optical systems. However, such image pickup optical systems having retractable construction involve complication of the structure of the barrel thereby increasing the cost. Further, in cases where the lenses are structured to be evolved after power-on of the apparatuses, it will take predetermined time before the completion of preparation for photographing, which may cause the problem that the photographer misses shutter chances even if he or she finds an object that he or she wants to photograph during the time.

As other means for compacting image pickup optical systems, there have been known techniques for providing reflection surfaces on an optical path in the image pickup optical system. For example, JP-A No. 2004-163477, JP-A No. 2004-264343, JP-A No. 2004-264585 and JP-A No. 2004-212737 make various suggestions about image pickup optical systems of this type. JP-A No. 2004-163477 discloses a technique for folding an optical axis by 90 degree using prisms or mirrors for realizing thickness reduction. However, such prisms and mirrors have no optical power and are equivalent to a glass flat plate and an air space. Accordingly, such additional components (prisms or mirrors) which will not contribute to the optical performance are required, which increases the number of components, thus increasing the cost.

In order to overcome the problem, there have been suggested image pickup optical systems which include a prism having an incidence surface or an emission surface having optical power. For example, JP-A No. 2004-264343 and JP-A No. 2004-264585 disclose image pickup optical systems including a prism for folding an optical axis by 90 degree, wherein the prism is formed to have a concave-shaped incidence surface (object-side surface) thereby having negative optical power. In these image pickup optical systems, the prism is formed to have a flat emission surface. Further, JP-A No. 2004-212737 discloses an image pickup optical system which includes a prism having a convex-shaped incidence surface having positive optical power and a concave-shaped emission surface having negative optical power.

By employing prisms having optical power as in the image pickup optical systems disclosed in the aforementioned JP-A No. 2004-264343, JP-A No. 2004-264585 and JP-A No. 2004-212737, it is possible to reduce the thickness of the image pickup optical system and also to suppress the increase of the number of components and the increase of the cost. However, if the prisms are provided with optical power in such a manner as disclosed in JP-A No. 2004-264343, JP-A No. 2004-264585 and JP-A No. 2004-212737, this will cause unavoidable unnecessary light beams (stray light) incident to the prisms to be reflected by the emission surfaces and the reflection surfaces of the prisms toward the image surface together with light beams propagating along the optical axis and enter the image pickup device, which may cause ghosts and the like, thus degrading the image quality, as will be described in detail on the basis of FIGS. 3 and 4.

### SUMMARY OF THE INVENTION

It is an object of the present invention to optimize a compact image pickup optical system having excellent optical performance while suppressing the increase of the cost, particularly the shape of the emission surface of a reflection prism therein to provide an image pickup optical system and an image pickup apparatus incorporating such an image pickup optical system which can be suitably mounted on a cellular phone or a portable information terminal having a small thickness and can suppress the degradation of the image quality due to unnecessary light beams while enabling compaction.

An image pickup optical system according to the present invention includes a reflection prism for reflecting incident light while reflecting it by about 90 degree, wherein the reflection prism is formed to have a convex-shaped emission surface. The convex-shaped emission surface of the reflection prism can reduce the amount of unnecessary light beams (stray light) reflected by the emission surface of the reflection prism and also can diffuse the unnecessary light beams reflected by the emission surface and the reflection surface of the reflection prism, which can significantly reduce the amount of the unnecessary light beams directed toward the image surface. This can suppress the degradation of the image quality due to unnecessary light beams while compacting the image pickup optical system.

An image pickup apparatus according to a second invention includes the aforementioned image pickup optical system and an image pickup device, wherein the image pickup optical system forms optical images of an object on the image pickup device. This enables provision of a compact and accurate image pickup apparatus mountable on, for example, a cellular phone or a portable information terminal.

Further, a digital apparatus according to a third invention includes the aforementioned image pickup apparatus. By incorporating the compact image pickup apparatus, it is possible to provide a compact and small-size cellular phone, portable terminal device or the like having a photographing function.

The invention itself, together with further objects and attendant advantages, will best be understood by reference to the following detailed description taken in conjunction with the accompanying drawings.

### BRIEF DESCRIPTION OF THE DRAWINGS

FIG. 1 is a view schematically illustrating an image pickup optical system employing two reflection prisms according to the present invention.

FIG. 2 is a view schematically illustrating an image pickup optical system employing a single reflection prism placed near an object according to the present invention.

FIG. 3 is a view schematically illustrating an image pickup optical system employing a single reflection prism placed near an image pickup device according to the present invention.

FIGS. 4A and 4B are optical-path diagrams illustrating the optical path of an unnecessary light beam in a conventional reflection prism, wherein FIG. 4A is an optical-path diagram in a reflection prism having a flat-shaped emission surface and FIG. 4B is an optical-path diagram in a reflection prism having a concave-shaped emission surface.

FIG. 5 is an optical-path diagram illustrating the optical path of an unnecessary light beam in a reflection prism having a convex-shaped emission surface according to the present invention.

FIG. 6 is a schematic view illustrating a preferable structure of a reflection prism according to the present invention.

FIGS. 7A and 7B are optical-path diagrams illustrating the relationship between an incidence-side prism and a light ray, wherein FIG. 7A is an optical-path diagram in a prism having no optical power and FIG. 7B is an optical-path diagram in a prism having optical power.

FIGS. 8A and 8B are cross-sectional views illustrating image-surface side prisms having infrared-radiation cutting functions, wherein FIG. 8A illustrates a case where an infrared-radiation reflection film is integrally provided on the emission surface of an image-surface side prism and FIG. 8B illustrates a case where an infrared-radiation absorption film is integrally provided on the reflection surface of an image-surface side prism.

FIG. 9 is a perspective view tri-dimensionally illustrating the image pickup optical system illustrated in FIG. 1

FIG. 10 is a schematic view of an optical path in the image pickup optical system illustrated in FIG. 9.

FIG. 11 is a view schematically illustrating the structure of a variable-power optical system according as another embodiment of the image pickup optical system according to the present invention.

FIGS. 12A to 12C are external structural views of a camera-equipped cellular phone incorporating an image pickup optical system (a variable-power optical system) according to the present invention, wherein FIG. 12A is an external structural view illustrating an operation surface thereof,

FIG. 12B is an external structural view illustrating the surface opposite from the operation surface, and FIG. 12C is an external structural view illustrating the cellular phone incorporating a variable-power optical system.

FIGS. 13A and 13B are external structural views of a foldable-type cellular phone, wherein FIG. 13A is an external structural view illustrating an operation surface thereof, and FIG. 13B is an external structural view illustrating the surface opposite from the operation surface.

FIGS. 14A and 14B are external structural views of a portable information terminal device, wherein FIG. 14A is an external structural view illustrating an operation surface thereof, and FIG. 14B is an external structural view illustrating the surface opposite from the operation surface.

FIG. 15 is a view illustrating the placement of optical devices in an image pickup optical system according to a first embodiment of the present invention at a state where they are focused at infinity.

FIG. 16 is a view illustrating the placement of optical devices in an image pickup optical system according to a modified aspect of the first embodiment of the present invention at a state where they are focused at infinity.

FIG. 17 is a view illustrating the structure of an image pickup optical system structured by replacing the reflection prism in FIGS. 15 and 16, with lenses having functions substantially equivalent to those of the aforementioned reflection prism.

FIG. 18 is a view illustrating the placement of optical devices in an image pickup optical system according to a second embodiment of the present invention at a state where they are focused at infinity.

FIG. 19 is a view illustrating the structure of an image pickup optical system structured by replacing the reflection prism in FIG. 18, with lenses having functions substantially equivalent to those of the aforementioned reflection prism.

FIG. 20 is a view illustrating the placement of optical devices in an image pickup optical system according to a third embodiment of the present invention at a state where they are focused at infinity.

FIG. 21 is a view illustrating the structure of an image pickup optical system structured by replacing the reflection prism in FIG. 20, with lenses having functions substantially equivalent to those of the aforementioned reflection prism.

FIG. 22 is a view illustrating the placement of optical devices in an image pickup optical system according to a fourth embodiment of the present invention at a state where they are focused at infinity.

FIG. 23 is a view illustrating the structure of an image pickup optical system structured by replacing the reflection prism in FIG. 22, with lenses having functions substantially equivalent to those of the aforementioned reflection prism.

FIG. 24 is a view illustrating the placement of optical devices in an image pickup optical system according to a fifth embodiment of the present invention at a state where they are focused at infinity.

FIG. 25 is a view illustrating the structure of an image pickup optical system structured by replacing the reflection prism in FIG. 24, with lenses having functions substantially equivalent to those of the aforementioned reflection prism.

FIG. 26 is a longitudinal cross-sectional view of an image pickup optical system (a variable-power optical system) according to a sixth embodiment of the present invention, taken along an optical axis.

FIG. 27 is a longitudinal cross-sectional view of a variable-power optical system structured by replacing the reflection prisms in FIG. 26 with lenses having functions substantially equivalent to those of the reflection prism, taken along an optical axis.

FIG. 28 is a longitudinal cross-sectional view of an image pickup optical system (a variable-power optical system) according to a seventh embodiment of the present invention, taken along an optical axis.

FIG. 29 is a longitudinal cross-sectional view of a variable-power optical system structured by replacing the reflection prisms in FIG. 28 with lenses having functions substantially equivalent to those of the reflection prism, taken along an optical axis.

FIG. 30 is an aberration diagrams representing the spherical aberration, the astigmatism and the distortion of the lenses in an image pickup optical system according to an example 1.

FIG. 31 is an aberration diagrams representing the spherical aberration, the astigmatism and the distortion of the lenses in an image pickup optical system according to an example 2.

FIG. 32 is an aberration diagrams representing the spherical aberration, the astigmatism and the distortion of the lenses in an image pickup optical system according to an example 3.

FIG. 33 is an aberration diagrams representing the spherical aberration, the astigmatism and the distortion of the lenses in an image pickup optical system according to an example 4.

FIG. 34 is an aberration diagrams representing the spherical aberration, the astigmatism and the distortion of the lenses in an image pickup optical system according to an example 5.

FIG. 35 is an aberration diagrams representing the spherical aberration, the astigmatism and the distortion of the lenses in an image pickup optical system according to an example 6, at an infinity focusing state.

FIG. 36 is an aberration diagrams representing the spherical aberration, the astigmatism and the distortion of the lenses in an image pickup optical system according to an example 7, at an infinity focusing state.

In the following description, like parts are designated by like reference numbers throughout the several drawing.

### DETAILED DESCRIPTION OF THE PREFERRED EMBODIMENTS

Hereinafter, with reference to the drawings, there will be described image pickup optical systems, image pickup lens devices and digital apparatuses according to the present invention. However, the present invention is not limited to these embodiments.

[Description of the Structures of Image Pickup Optical Systems]

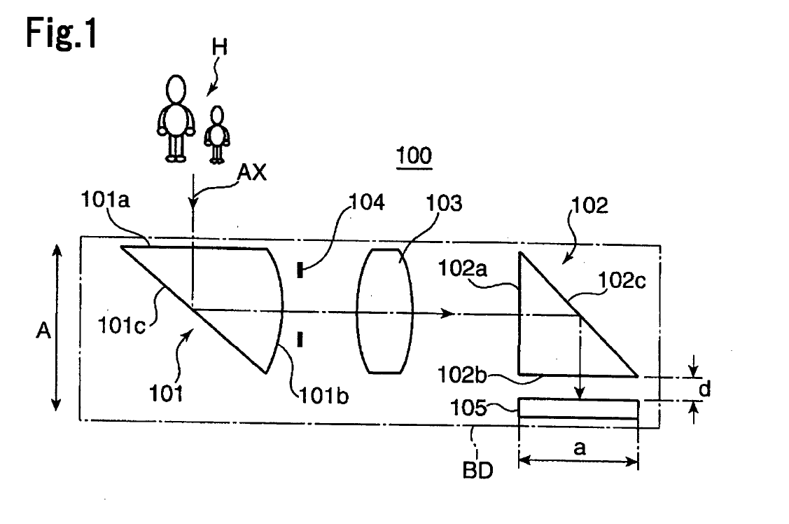

FIG. 1 is a view schematically illustrating the structure of an image pickup optical system 100 according to the present invention. The image pickup optical system 100 forms an optical image of an object H on the light receiving surface of an image pickup device 105 which converts optical images into electrical signals. The image pickup optical system 100 includes two reflection prisms which reflect incident light while refracting it by a predetermined angle (about 90 degrees), namely an object-side reflection prism 101 placed near the object H on the optical path (hereinafter, referred to as “an incidence-side prism 101”) and an image-pickup-device side prism 102 placed near the image pickup device 105 on the optical path (hereinafter, referred to as “an image-surface side prism 102”). Further, there are placed a focusing lens 103 and an optical diaphragm 104, as required, between the incidence-side prism 101 and the image-surface side prism 102.

Further, the incidence surface 101a of the aforementioned incidence-side prism 101 and the emission surface 102b of the image-surface side prism 102 are placed substantially parallel to each other. Namely, the optical axis AX from the object H to the image pickup device 105 is folded by 90 degree at the reflection surfaces 101c and 102c of the incidence-side prism 101 and the image-surface side prism 102. The aforementioned image pickup optical system 100 is housed within a cabinet BD of one of various types of digital apparatuses (for example, cellular phones).

Further, while FIG. 1 exemplifies the image pickup optical system 100 which utilizes the two reflection prisms to fold incident light by about 90 degree only twice so that the incidence surface 101a of the incidence-side prism 101 and the emission surface 102b of the image-surface side prism 102 are substantially parallel to each other, it is possible to structure an optical system which utilizes three or more reflection prisms to form a two-dimensional or three-dimensional optical path within the cabinet BD so that the incidence surface 101a and the emission surface 102b are substantially parallel to each other or not substantially parallel to each other.

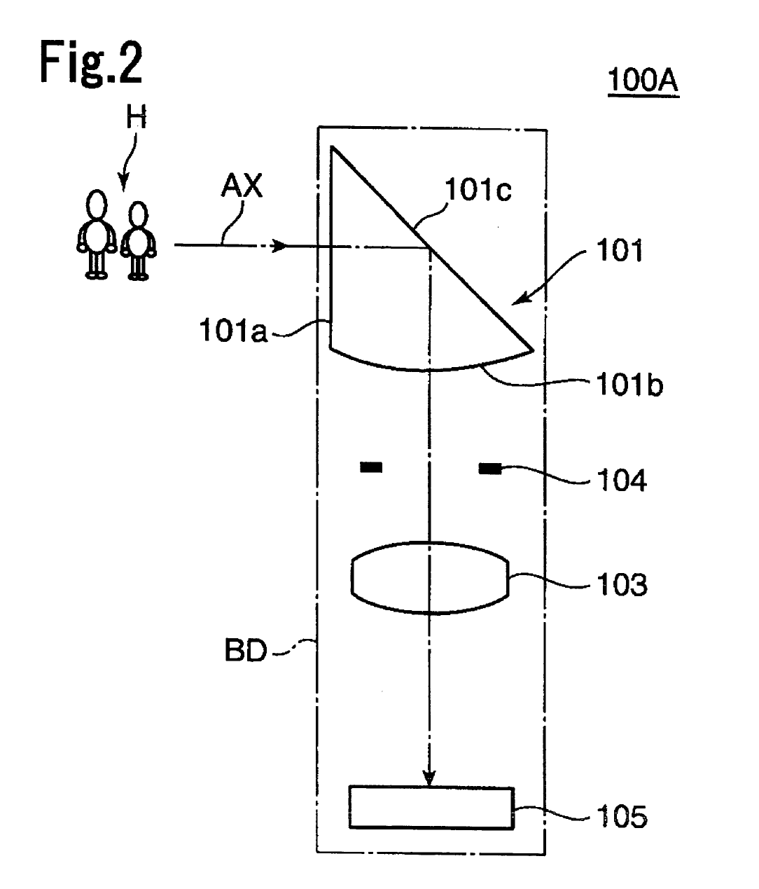

Further, as an image pickup optical system 100A illustrated in FIG. 2, only the incidence-side prism 101 may be placed at a position closest to the object H on the optical path. In such an image pickup optical system 100A, the optical axis AX from the object H to the image pickup device 105 is folded by about 90 degree at the reflection surface 101c of the incidence-side prism 101.

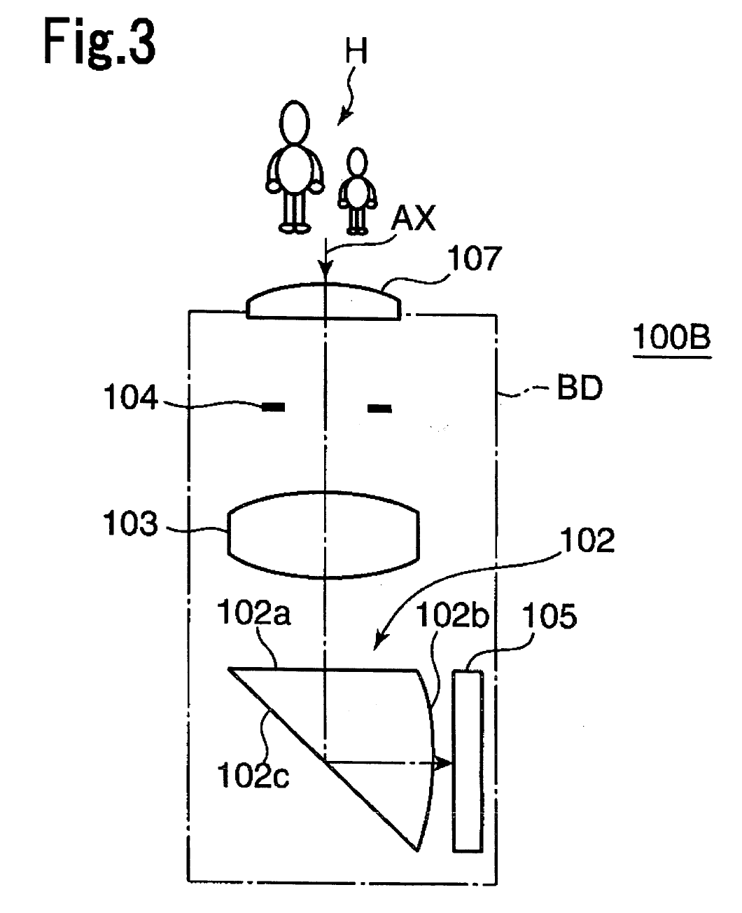

Also, as an image pickup optical system 100B illustrated in FIG. 3, only the image-surface side prism 102 may be placed near the light receiving surface of the image pickup device 105. In such an image pickup optical system 100B, the optical axis AX from the object H to the image pickup device 105 is passed through an incidence lens 107 and then is folded by about 90 degree at the reflection surface 102c of the image-surface side prism 102. As described above, various types of optical structures may be employed in the present invention and, in the following description of embodiments, the image pickup optical system 100 illustrated in FIG. 1 will be mainly described.

The aforementioned image pickup device 105 photoelectrically converts optical images of the object H formed by the aforementioned image pickup optical system 100, into image signals with R, G and B components, according to the light quantities of the optical image, and outputs the image signals to a predetermined image processing circuit. For example, as the image pickup device 105, it is possible to employ an image pickup device constituted by a single-plate type color area sensor which is so-called a Bayer type color area sensor. Such a Bayer type color area sensor includes an area sensor constituted by CCDs (Charge Coupled Devices) placed in a two-dimensional shape, and R (red), G (green) and B (blue) color filters attached in a checkered shape to the surfaces of the respective CCDs in the area sensor. As well as such a CCD image sensor, it is also possible to employ a CMOS image sensor, a VMIS image sensor or the like.

In this case, when the image pickup device 105 has a rectangular shape with longer sides and shorter sides, it is preferable that the light ray is folded in the direction of the shorter sides of the image pickup device 105 (the direction of the shorter sides is the widthwise direction designated by an arrow a in FIG. 1). Although the light ray can be folded in the direction of the longer sides of the image pickup device 105 to reduce the thickness of the image pickup optical system 100, it is possible to reduce the thickness of the image pickup optical system 100 more largely by folding the light ray in the direction of the shorter sides of the image pickup device 105.

In the aforementioned image pickup optical system 100, a reflection prism is formed to have a convex emission surface, in the present invention. For example, in the image pickup optical system 100 illustrated in FIG. 1, the incidence-side prism 101 is formed to have a convex emission surface 101b. This applies to the image pickup optical system 100A illustrated in FIG. 2. Further, in the image pickup optical system 100C illustrated in FIG. 3, the image-surface side prism 102 is formed to have a convex emission surface 102b.

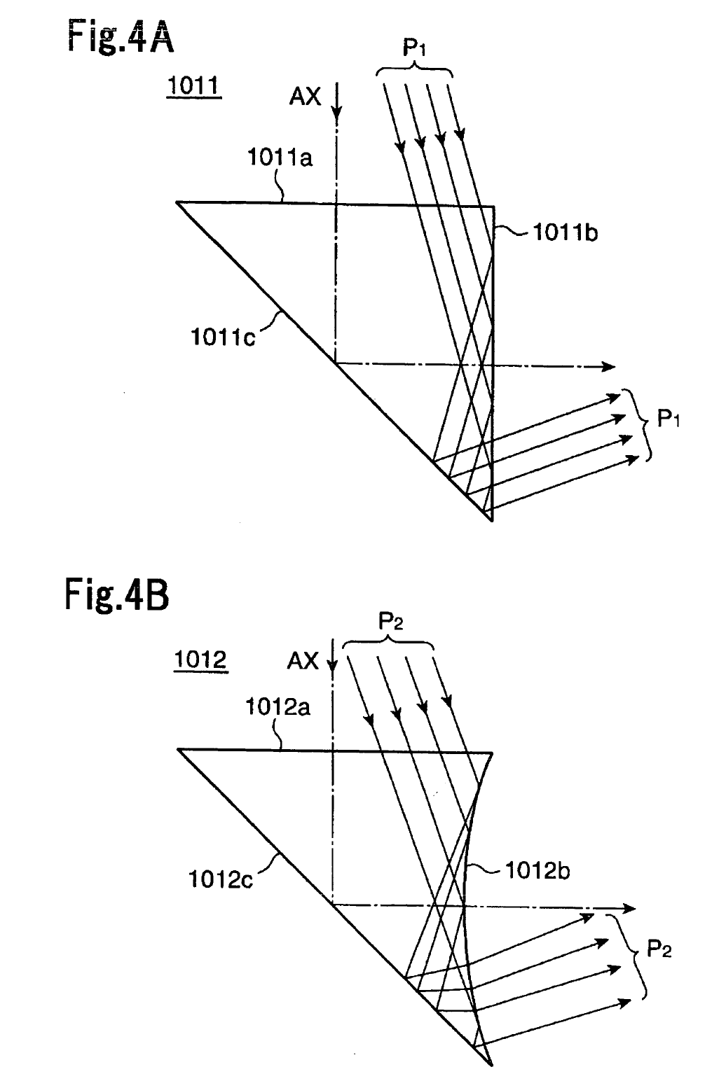

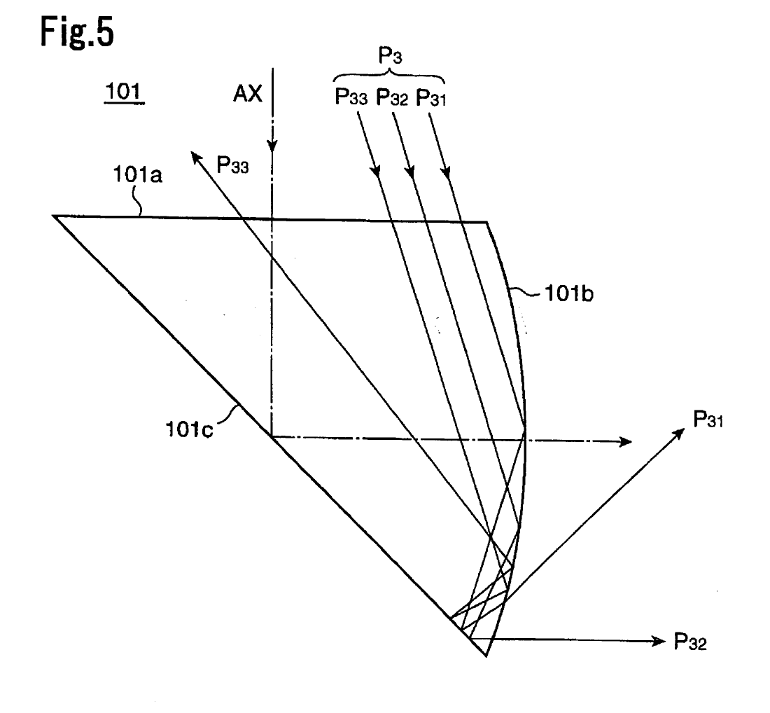

The significance of forming the convex emission surface 102b will be described on the basis of FIGS. 4 and 5. First, FIG. 4A is a cross-sectional view illustrating a reflection prism 1011 having an incidence surface 1011a, an emission surface 1011b and a reflection surface 1011c, wherein the emission surface 1011b is a flat surface having no optical power. A light beam of the object H enters the incidence surface 1011a along the optical axis AX, then reflected by the reflection surface 101c, passed through the emission surface 1011b without interruption and then is directed to the image pickup device 105. However, the light beam which enters the incidence surface 1011a includes an unnecessary light beam (stray light) P1 propagating toward the emission surface 1011b, without directly propagating to the reflection surface 1011c.

The unnecessary light beam P1 is totally reflected by the emission surface 1011b which is a flat surface, then is reflected by the reflection surface 1011c and is emitted from the emission surface 1011b without being diffused. Such an unnecessary light beam P1 is directed to the image surface along the optical axis AX which has been folded by 90 degree at the reflection surface 1011c and enters the image pickup device 105. Accordingly, the components of the aforementioned unnecessary light beam P1 appear as a ghost on an image captured by the image pickup device 105, thereby resulting in degradation of the image quality.

Next, FIG. 4B is a cross-sectional view illustrating a reflection prism 1012 having an incidence surface 1012a, an emission surface 1012b and a reflection surface 1012c, wherein the emission surface 1012b is formed to be a concave surface. In this case, an unnecessary light beam P2 propagating to the emission surface 1012b without directly propagating to the reflection surface 1012c is reflected by the emission surface 1012b which is a concave surface, then is reflected by the reflection surface 1012c and is emitted from the emission surface 1012b while being diffused to some degrees. As described above, when the emission surface 1012b is a concave surface, the unnecessary light beam P2 is directed to the image surface along the optical axis AX while being diffused to some degrees. Furthermore, since the emission surface 1012b is a concave surface, the emission surface 1012b is, figuratively speaking, in a state where it can not easily accept the unnecessary light beam P2, which increases the amount of unnecessary light beam P2 entering the incidence surface 1012a and being directly reflected by the emission surface 1012b. This tends to cause appearance of ghosts.

On the other hand, FIG. 5 is a cross-sectional view illustrating a reflection prism (an incidence-side prism 101) according to the present invention having a convex-shaped emission surface 101b. In this case, since the emission surface 101b is a convex surface, the emission surface 101b is, figuratively speaking, in a receptive state, on the contrary to the case of a concave surface. Namely, the emission surface 101b having a convex shape reduces the absolute amount of an unnecessary light beam P3 propagating to the emission surface 101b without directly propagating to the reflection surface 101c. Namely, if the emission surface 1012b is a concave surface as in FIG. 4B, substantially the entire emission surface 1012b forms a reflection surface for the unnecessary light beam P2. However, when the emission surface 101b is a convex surface as in FIG. 5, only a lower portion of the emission surface 101b forms a reflection surface for the unnecessary light beam P3, depending on the curvature and the like of the convex surface.

Further, the unnecessary light beam P3 reflected by the emission surface 101b is largely diffused, which significantly reduces the amount of the unnecessary light beam P3 directed to the image surface along the optical axis AX. For example, as illustrated in FIG. 5, a light beam P31 reflected by the near-center portion of the emission surface 101b and a light beam P32 reflected by the lower portion of the emission surface 101b are both reflected by the reflection surface 101c and then are emitted from the emission surface 101b while being largely diffused thereby. Further, a light beam P33 reflected by the emission surface 101b near the lower portion thereof is reflected by the reflection surface 101c, then is reflected by the emission surface 101b and is directed to the incidence surface 101a. As described above, the emission surface 101b having a convex shape can reduce the amount of the unnecessary light beam P3 reflected by the emission surface 101b and also can largely diffuse the unnecessary light beam P3, which significantly reduces the components of the unnecessary light beam entered to the image pickup device 15, thereby suppressing the degradation of the image quality.

While the aforementioned emission surface 101b is only required to have a convex shape, it is desirable that the absolute value of the radius of curvature CR thereof falls within the following range.
1<|CR|<20

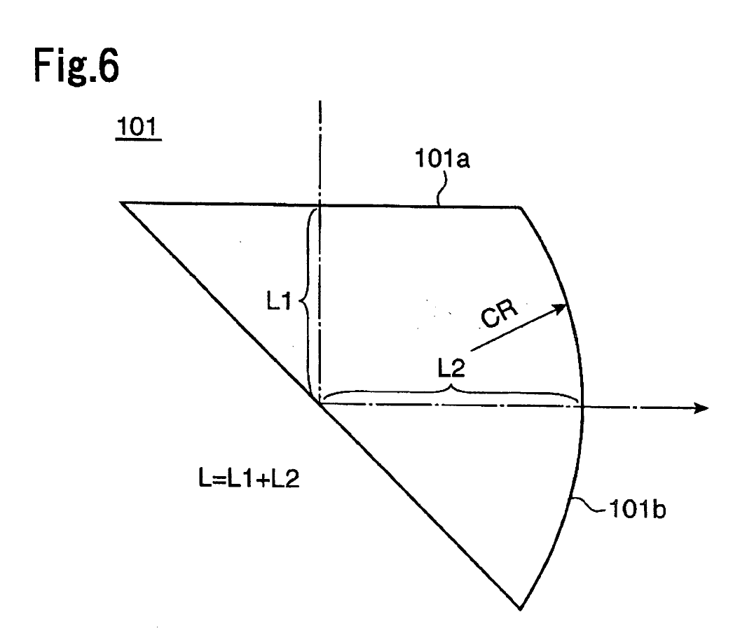

If the absolute value of the radius of curvature is increased, this will reduce the receptivity of the emission surface, thereby reducing the effect of diffusing light beams. Further, if the absolute value of the radius of curvature is small, this will increase the difficulty of fabrication of the prism. Further, as illustrated in FIG. 6, it is desirable that the radius of curvature CR of the emission surface 101b of the incidence-side prism 101 and the physical length L of the on-axis principal ray along the axis from the incidence surface 101a of the incidence-side prism 101 to the emission surface 101b of the incidence-side prism 101 satisfies the relationship of the following formula (1).
−10<CR/L<−0.3 (1)

By satisfying the relationship of the aforementioned formula (1), it is possible to optimize the relationship between the radius of curvature CR of the emission surface 101b of the incidence-side prism 101 and the physical length L of the main light ray along the axis, thereby further reducing the unnecessary light beam propagating toward the image surface. If the upper limit in the aforementioned formula (1) is exceeded, the curvature of the emission surface 101b becomes excessively large, thereby increasing aberrations. Further, if the value of CR/L is below the lower limit, the radius of curvature becomes excessively small and the emission surface 101b becomes closer to a flat surface, which tends to cause ghosts. It is more desirable that the aforementioned radius of curvature CR and the physical length L of the main light ray along the axis satisfy the relationship of the following formula (1-1).
−5<CR/L<−0.5 (1-1)

The emission surface 101b having a convex shape may be a spherical surface, but it is preferably an aspherical surface. By forming the emission surface 101b to be an aspherical surface, it is possible to increase the degree of flexibility in the optical design, which enables compacting the image pickup optical system and also enables sufficient correction of astigmatisms and distortion aberrations. Further, this increases the degree of flexibility in the adjustment of the incidence angle of an optical image with respect to the image pickup device 105, which enables reducing the difference of the incidence angle with respect to the image pickup device 105 between the wide angle end and the telephoto end, thereby providing images with smaller light-quantity degradation around their periphery.

Subsequently, there will be described a preferable optical structure of the aforementioned image pickup system 100. First, there will be described desirable placement of the emission surface 102b of the image-surface side prism 102 and the image pickup device 105. The size of the image pickup optical system 100 in the direction of an arrow A can be reduced, by setting the direction of movement of the focusing lens 103 and the direction of placement of a image-pickup-device holder (not illustrated) including the image pickup device 105 which requires a width to the direction of the greater thickness of the cabinet BD. However, in the case where the image pickup device 105 is placed to be faced with the emission surface 102b of the image-surface side prism 102 (the emission surface 102b is assumed to be a flat surface) and they are housed within the cabinet BD, it is desirable to reduce the distance between the emission surface 102b of the image-surface side prism 102 and the image pickup device 105 as much as possible, in order to reduce the thickness of the cabinet BD.

Further, it is desirable to set the placement of the emission surface 102b of the image-surface side prism 102 and the image pickup device 105 such that the following formula (2) is satisfied, in view of reduction of the thickness of the cabinet BD, wherein the distance between the emission surface 102b of the image-surface side prism 102 and the light receiving surface of the image pickup device 105 is defined as d (this also means a physical length of when optical components are interposed between the emission surface 102b and the light receiving surface of the image pickup device 105), and the height of the light receiving surface of the image pickup device 105 in the optical-path folding plane (corresponding to the paper plain of FIG. 1) in the image pickup optical system 100 is defined as a (or example, the direction of the shorter sides of the image pickup device 105).
0.0≦d/a<1.0 (2)

In the aforementioned formula (2), if the value of d/a exceeds 1.0, the distance d between the emission surface 102b of the image-surface side prism 102 and the image pickup device 105 becomes excessively large, which is not preferable for reduction of the thickness of the cabinet BD. Namely, if the distance d is large, this requires the image-surface side prism 102 to have a greater size, in order to form an image on the light receiving surface of the image pickup device 105 in such an environment, which requires the entire image pickup optical system 100 to have a larger size (a larger thickness).

On the other hand, the value of d/a can be set to 0 to bring the emission surface 102b of the image-surface side prism 102 into intimate contact with the light receiving surface of the image pickup device 105, in order to minimize the size in the direction of the arrow A, which is a desirable aspect in view of thickness reduction. However, this aspect increases the difficulty of assembly, since the aforementioned emission surface 102b is brought into contact with the light receiving surface of the image pickup device 105. Furthermore, this aspect causes concerns about the occurrence of ghosts due to reflections caused between the emission surface 102b and the light receiving surface of the image pickup device 105. In order to eliminate such inconvenience, it is desirable to set the lower limit value of d/a to 0.1 or more.

In addition to forming the emission surface 101b of the aforementioned incidence-side prism 101 to be a convex surface as previously described, it is preferable to form any one or two or all of the incidence surface 101a of the incidence-side prism 101 and the incidence surface 102a and the emission surface 102b of the image-surface side prism 102 to have optical powers. Such structures enables utilizing the incidence surfaces 101a and 102a or the emission surface 102b as surfaces having lens functions, which can eliminate the necessity of additional optical devices corresponding thereto, thereby compacting the image pickup optical system 100.

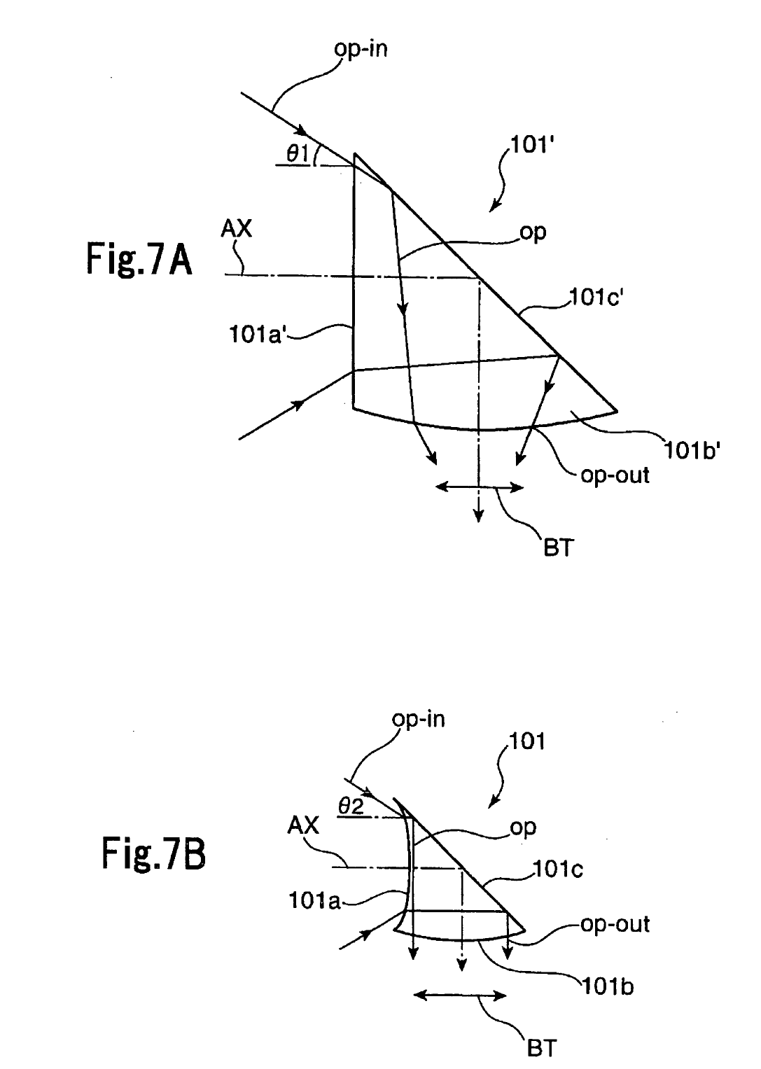

In the case where the incidence-side prism 101 is placed at a position closest to the object H on the optical path, and the optical diaphragm 104 is positioned near the emission surface 101b of the incidence-side prism 101, if the incidence surface 101a of the incidence-side prism 101 is configured to have negative optical power (a concave surface), this will provide advantages as follows. FIGS. 7A and 7B are optical-path diagrams illustrating the relationship between the incidence-side prism 101 (101′) and a light ray. In the case where a predetermined light-ray width BT is required to be emitted from the incidence-side prism 101 (101′), in order to reduce the size of the prism itself, it is desirable that a light ray op propagating through a most peripheral portion of the prism is emitted as an emitted light ray op-out substantially parallel to the optical axis AX.

Namely, as the incidence-side prism 101′ of FIG. 7A, if the incidence surface 101a′ is a flat surface, this will cause an incident light ray op-in having an angle of θ1 at a most peripheral position, out of light rays entering the incidence surface 101a′, to have a large angle with respect to the optical axis AX, thus resulting in emission of an emitted light ray op-out with an inclination angle with respect to the optical axis AX. Accordingly, in order to provide a predetermined light-ray width BT, it is necessary to extend the incident surface 101a′ and the emission surface 101b′ in consideration of the aforementioned inclination angle, which requires increasing the size of the prism.

On the other hand, as an incidence-side prism 101 of FIG. 7B, if the incidence surface 101a is configured to have negative optical power (a concave surface), this will cause an incident light ray op-in having an angle of θ2 at a most peripheral position, out of light rays entering the incidence surface 101a, to have a small angle with respect to the optical axis AX, thus resulting in an emission of an emitted light ray op-out substantially parallel to the optical axis AX. This can significantly reduce the size of a prism which can provide a predetermined light-ray width BT, in comparison with the case of FIG. 7A, thereby compacting the image pickup optical system 100.

Further, it is desirable that no optical devices having refracting forces (optical powers) are placed on the optical path between the object H and the incidence surface 101a of the incidence-side prism 101 and between the image (the image pickup device 105) and the emission surface 102b of the image-surface side prism 102, and optical devices having refracting forces are placed on the optical path only between the incidence surface 101a of the incidence-side prism 101 and the emission surface 102b of the image-surface side prism 102, as in the image pickup optical system 100 illustrated in FIG. 1. This can reduce the thickness (the size in the direction of the arrow A) of the image pickup optical system 100, thereby suppressing the increase of the size of the image pickup optical system 100, in comparison with cases where optical devices having refracting forces are placed on the optical path between the object H and the incidence surface 101a of the incidence-side prism 101.

Further, it is desirable to place a lens or lenses between the incidence-side prism 101 and the image-surface side prism 102 in the aforementioned image pickup optical system 100. This is because such a lens or lenses can correct field curvatures, aberrations and the like to improve the optical performance of the image pickup optical system 100. In the case of placing a lens or lenses as described above, by employing a lens or lenses having a size or sizes smaller in the direction of the arrow A than the reflection prisms, it is possible to prevent the occurrence of the problem of size increase in the direction of the arrow A due to the mounting of the lens or lenses.

Further, it is preferable to structure the image pickup optical system to drive the lens or lenses in the direction of the optical axis (the direction substantially parallel to the incident surface 101a of the incidence-side prism 101) to perform focusing. This is because of the following reason. If the entire image pickup optical system including the reflection prisms is structured to be driven in the direction of the optical axis, this will cause an increase of the size of the motor due to the increase of the weight of the driven components, deviations of the optical axis due to the aforementioned driving, or complication of the mechanism for holding the respective optical devices in the image pickup optical system. By placing a lens or lenses between the two reflection prisms, it is possible to secure the reflection prisms and the optical diaphragm. Further, by driving the lens or lenses in the direction of the optical axis, it is possible to overcome the problems of a size increase of the motor, the occurrence of deviations of the optical axis and complication of the aforementioned holding mechanism.

In the image pickup optical system 100 illustrated in FIG. 1, in order to satisfy the aforementioned requirements, the focusing lens 103 is placed between the incidence-side prism 101 and the image-surface side prism 102. Namely, the image pickup optical system is structured to move the focusing lens 103 in the direction parallel to the incidence surface 101a of the incidence-side prism 101 for focusing.

Further, in the aforementioned image pickup optical system 100, it is preferable that the respective optical surfaces in the image pickup optical system 100 are formed to be axially symmetrical about the optical axis AX (rotationally symmetrical), in view of ease of the fabrication of the incidence-side prism 101, the image-surface side prism 102 and the lens 103. If the optical system is formed to be axially asymmetrical, this will increase the difficulty of fabrication thereof and also increase the difficulty of evaluations and adjustments during assembly thereof, thereby increasing the cost. Accordingly, such an axially asymmetrical optical system is undesirable. On the contrary, if such a cost increase can be permitted, it is possible to employ axially-asymmetrical reflection surfaces.

On the other hand, if a CCD image sensor or a CMOS image sensor is employed as the image pickup device 105, infrared radiation components may become noises to degrade output images. Therefore, there have conventionally been taken measures for preventing infrared radiation components from entering the image pickup device 105, by placing an infrared-radiation cutting filter or the like at a proper position in an image pickup optical system. However, this requires an additional optical component having the function of cutting infrared radiations, which has been a factor inhibiting the compaction of the optical image pickup optical system and the reduction of the number of components.

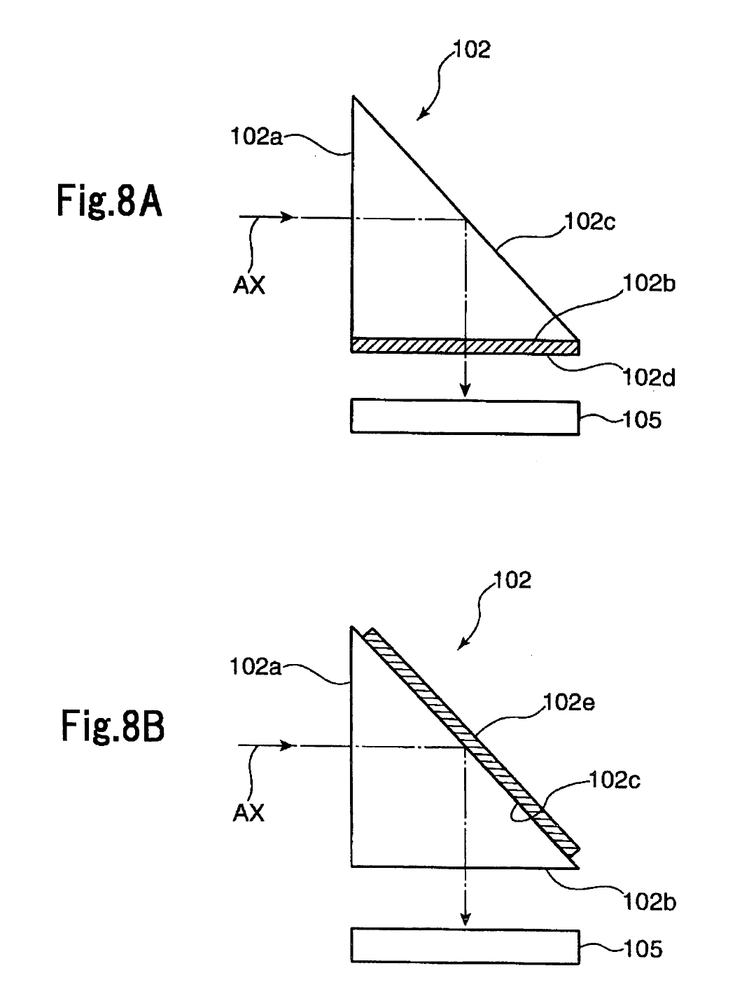

Therefore, it is desirable that the image-surface side prism 102 itself has an infrared-radiation cutting function of reducing or eliminating infrared radiation components included in incident light. FIGS. 8A and 8B are cross-sectional views illustrating an exemplary image-surface side prism 102 having an infrared radiation cutting function. FIG. 8A illustrates a case where an infrared-radiation reflection film 102d is integrally provided on the emission surface 102b of the image-surface side prism 102. In this case, infrared radiation components included in incident light are reflected by the infrared-radiation reflection film 102d to be prevented from entering the image pickup device 105. For example, a dielectric multi-film coating layer can be preferably employed as such an infrared-radiation reflection film 102d. Also, such an infrared-radiation reflection film 102d may be provided on the incidence surface 102a of the image-surface side prism 102.

FIG. 8B illustrates a case where an infrared-radiation absorption film 102e is integrally formed on the reflection surface 102c of the image-surface side prism 102. In this case, infrared radiation components included in incident light are absorbed by the infrared-radiation absorption film 102e to be prevented from entering the image pickup device 105. For example, a dielectric multi-film coating layer capable of absorbing light with wavelengths in the infrared region may be preferably employed, as such an infrared-radiation reflection film 102e. Also, instead of such an infrared-radiation absorption film 102e, an infrared-radiation transparent film may be provided on the reflection surface 102c to cause only infrared radiation components to be emitted from the image-surface side prism 102.

Then, there will be described the material and the fabrication method of the incidence-side prism 101 and the image-surface side prism 102. There are no particular limitations on the materials of these prisms, and it is possible to employ any optical materials having a predetermined light transmittance and a predetermined refractive index, such as various types of glass materials and resin (plastic) materials. However, the use of a plastic material enables weight reduction and mass production through injection molding or the like and, therefore, has advantageous in terms of reduction of the cost and the weight of the image pickup optical system 100, over the case of forming the prisms from glass materials. Further, in the case of fabricating a reflection prism having an incidence surface and/or an emission surface having a refracting force as previously described, the use of a plastic material enables easy fabrication using a form work or the like, while the use of a glass material requires polishing processing during fabrication.

However, injection molding involves some unavoidable thermal contraction after the molding, which may increase the difficulty of fabricating optical components which are required to have higher accuracy. The incidence-side prism 101 is required to have higher accuracy than the image-surface side prism 102. This is because the image-surface side prism 102 is closer to the image pickup device 105 than the incidence-side prism 101 and has relatively low sensitivity to errors. Accordingly, it is desirable to form at least the image-surface prism 102 from a plastic material and to select a plastic material or a glass material as the material of the incidence-side prism 101 according to the required accuracy. Also, in the case of using a glass mold lens, it is preferable to use a glass material with a glass transition temperature (Tg) of 400 or less ° C., in order to prevent the wear of the molding die as much as possible.

In the case of forming the incidence-side prism 101 and/or the image-surface side prism 102 from a plastic material, it is possible to use, as the plastic material, various types of optical plastic materials such as polycarbonate, PMMA or the like. It is desirable to select, out of them, a plastic material with a water absorption coefficient of 0.01 or less %. Plastic materials have a moisture absorption effect of being combined with water in air, and the occurrence of such moisture absorption may change the optical characteristics such as the refractive index, even when the prism is fabricated according to the design values. Accordingly, the use of a plastic material with a water absorption coefficient of 0.01 or less % enables construction of an image pickup optical system 100 which is not influenced by moisture absorption. As such a plastic material, it is possible to use, for example, ZEONEX (the name of a product manufactured by Nihon Zeon Corporation).

On the other hand, the refractive index of a plastic material largely changes with temperature change. Accordingly, if all the prisms and the lenses constituting the image pickup optical system 100 are formed from plastic lenses, this will cause concerns about fluctuations of the position of the image point of the image pickup optical system 100 in the event of changes of the ambient temperature. In the case of such an image pickup unit designed not to allow neglecting the fluctuation of the position of the image point, it is possible to employ both lenses made of a glass material (for example, glass mold lenses) and plastic lenses and to set their refractive indexes such that the fluctuation of the position of the image point can be cancelled among the plural prisms and lenses, in order to alleviate the problem of the aforementioned temperature characteristics.

It is also desirable to form the incidence-side prism 101, the image-surface side prism 102 and the other optical lenses from plastic composite components which exhibit smaller refractive index changes with temperature change. As such plastic composite components, it is possible to employ components formed by mixing inorganic particles into a plastic material.

In general, if particles are mixed in a transparent plastic material, this will cause light scattering to degrade the transmittance and, therefore, it has been difficult to use such plastic materials containing particles as optical materials. However, by employing particles having sizes smaller than the wavelength of a light beam transmitted therethrough, it is possible to substantially prevent scattering. A plastic material decreases its refractive index with increasing temperature, while inorganic particles increase their refractive indexes with increasing temperature. This enables causing their temperature dependencies to cancel each other, thereby substantially preventing the occurrence of refractive index changes thereof. More specifically, by dispersing inorganic particles with a maximum length of 20 nanometers or less into a plastic material as a matrix material, it is possible to make the plastic material to have a refractive index with significantly low temperature dependence. For example, by dispersing particles made of niobium oxide (Nb₂O₅) into an acrylic resin, it is possible to reduce the refractive index change due to temperature changes. By employing plastic composite components made of a plastic material and inorganic particles mixed and dispersed therein, as the incidence-side prism 101, the image-surface side prism 102 and the focusing lens 103 in the aforementioned image pickup optical system 100, it is possible to suppress the fluctuation of the position of the image point with temperature change in the entire image pickup lens system.

Hereinafter, there will be described the refractive index change with temperature. The refractive index change A with temperature is expressed by the following formula (3), wherein the refractive index n is differentiate with respect to the temperature t, on the basis of the Lorentz-Lorenz equation.

$$A = \frac{( {n}^{2} + 2 ) ( {n}^{2} - 1 )}{6 n} \{ ( - 3 α ) + \frac{1 \partial [ R ]}{[ R ] \partial t} \} \qquad ( 3 )$$

In the formula (3), a designates the thermal expansion coefficient and [R] designates molecular refraction.

In the case of a plastic material, the second term in the aforementioned formula (3) less contributes to the value A than the first term and can be substantially neglected. For example, a PMMA resin has a linear expansion coefficient of 7E-5 and, if this value is substituted into the aforementioned formula, this results in a value A of −1.2E-4 [/° C.], which substantially agrees with measurement values. More specifically, while conventional plastic materials have exhibited refractive index changes A of about −1.2E-4 [/° C.] with temperature, it is preferable to suppress the absolute value of the refractive index change A with temperature to below 8E-5 [/° C.]. It is more preferable to suppress the absolute value thereof to below 6E-5 [/° C.]. Table 1 illustrates the refractive index changes A (=dn/dT) of plastic materials applicable to the present embodiment with temperature.

TABLE 1

| | A (APPROXIMATE |
|---|---|
| PLASTIC MATERIAL | VALUE) [10⁻⁵/° C.] |
| POLYOLEFIN | −11 |
| MATERIAL | |
| POLYCARBONATE | −14 |
| MATERIAL | |

Further, inorganic materials applicable to the present embodiment exhibit refractive index changes A with temperature (=dn/dT), which are different from plastic materials in polarity. Table 2 illustrates them.

TABLE 2

| | A (APPROXIMATE |
|---|---|
| INORGANIC MATERIAL | VALUE) 10⁻⁵/° C.] |
| ALUMINUM OXIDE | 1.4 |
| ALON | 1.2 |
| BERYLLIUM OXIDE | 1.0 |
| DIAMOND | 1.0 |
| CALCIUM CARBONATE | 0.7 |
| TITANIUM POTASSIUM | 1.2 |
| PHOSPHATE | |
| MAGNESIUM ALUMINATE | 0.9 |
| MAGNESIUM OXIDE | 1.9 |
| QUARTZ | 1.2 |
| TELLURIUM OXIDE | 0.9 |
| YTTRIUM OXIDE | 0.8 |
| ZINC OXIDE | 4.9 |

As a method for fabricating the incidence-side prism 101 and/or the image-surface side prism 102, it is possible to exemplify a method of bonding a lens having optical power to a predetermined prism, a method of polishing a prism into curved surfaces, a method of using injection molding or glass molding and the like. However, such a method of bonding a lens to a prism and such a method of polishing a prism into curved surfaces involve burdensome axis adjustments for adjusting the positional relationship and the inclination of the reflection surface with respect to the aforementioned lenses or curved surfaces, which makes the difficulty of fabrication relatively high. On the contrary, injection molding using a resin (plastic) material is advantageous in terms of mass productivity as previously described and, therefore, is one of preferable fabrication methods.

In the case of employing a prism fabricated through injection molding as aforementioned, it is desirable to pay attentions to the following points. In the case of performing injection molding, there is a need for a gate for injecting a resin into a mold. While such a gate can be placed to face to any of the surfaces of the prism, it is desirable to place it to face to a surface of the prism which is not used for light incidence, emission, and reflection. This is because of the following reason. In general, the region around the gate has a tendency to cause birefringence, due to residues of resin flows, which may exert influences on the optical characteristics. The aforementioned placement can alleviate such influences even in the event of birefringence.

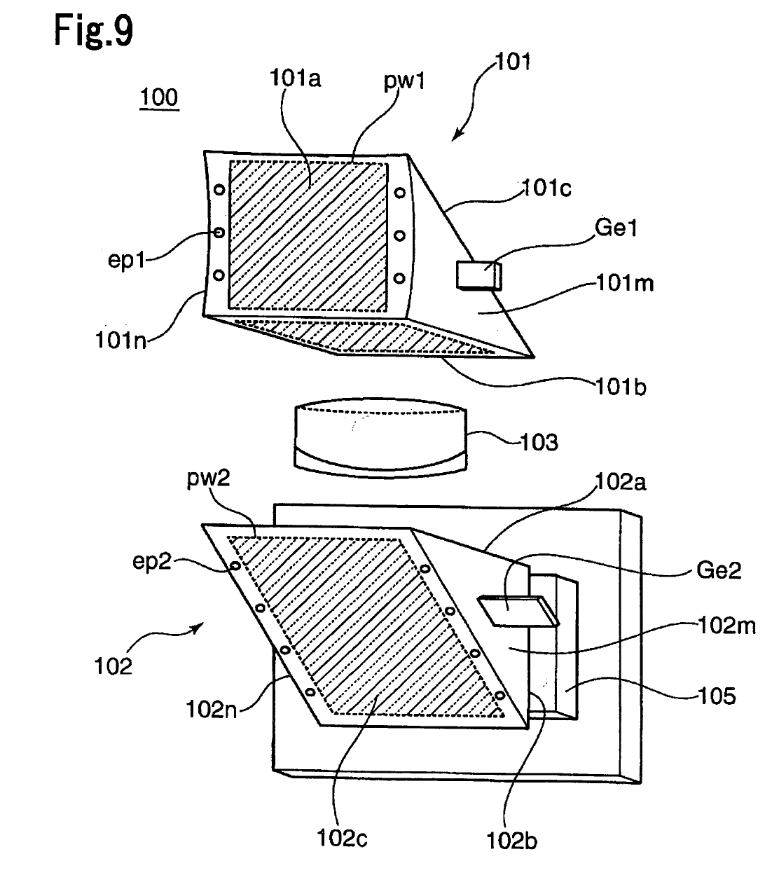

FIG. 9 is a perspective view tri-dimensionally illustrating the image pickup optical system 100 illustrated in FIG. 1 (the emission surface 101b is illustrated as a flat surface, for ease of illustration). On the basis of FIG. 9, the aforementioned desirable structure will be described. In the case of forming the incidence-side prism 101 through injection molding, the gate for injection into the mold is not placed on the incidence surface 101a, the emission surface 101b and the reflection surface 101c, but on an unused surface 101m at the sides of these surfaces. In this case, since such a gate has a prism shape with a rectangular cross-sectional area, in general, a gate mark Ge1 with such a prism shape (a gate mark Ge1 having a wider surface parallel to the incidence surface 101a) will be left on the aforementioned unused surface 101m (the gate mark Ge1 is illustrated in an exaggerated manner). By placing the gate as described above, even in the event of the occurrence of birefringence around the gate, it is possible to alleviate the influences thereof on the effective usable area pw1 of the incidence-side prism 101 (the hatched area in the figure; the area which allows light rays to pass therethrough).

Similarly, the gate for injection into the mold is not placed on the incidence surface 102a, the emission surface 102b and the reflection surface 102c of the image-surface side prism 102, but on an unused surface 102m at the sides of these surfaces. In this case, a prism-shaped gate mark Ge2 (a gate mark Ge2 having a wider surface parallel to the reflection surface 102c) will be left on the aforementioned unused surface 102m. However, similarly, even in the event of the occurrence of birefringence around the gate, it is possible to alleviate the influences thereof on the effective usable area pw2 of the image-surface side prism 102 (the hatched area in the figure).

When the molded article (the prism, in this case) is extracted from the mold after the injection molding, a method of pushing the molded article using an ejecting pin is commonly utilized. This may cause a mark to be left at the position which has been pushed by the ejecting pin, thereby causing fluctuations of the optical characteristics at the position. In the case illustrated in FIG. 9, the ejecting pin is placed in the portion corresponding to the unused area of the incidence surface 101a of the incidence-side prism 101, in order to cause pin marks ep1 to appear in the aforementioned unused area. Also, the ejecting pin is placed in the portion corresponding to the unused area of the reflection surface 102c of the image-surface side prism 102 to cause pin marks ep2 to appear in the unused area. Also, as a matter of cause, it is possible to place the ejecting pin such that pin marks ep1 and ep2 as aforementioned will appear on the unused surfaces 101n and 102n opposite from the unused surfaces 101m and 102m, respectively.

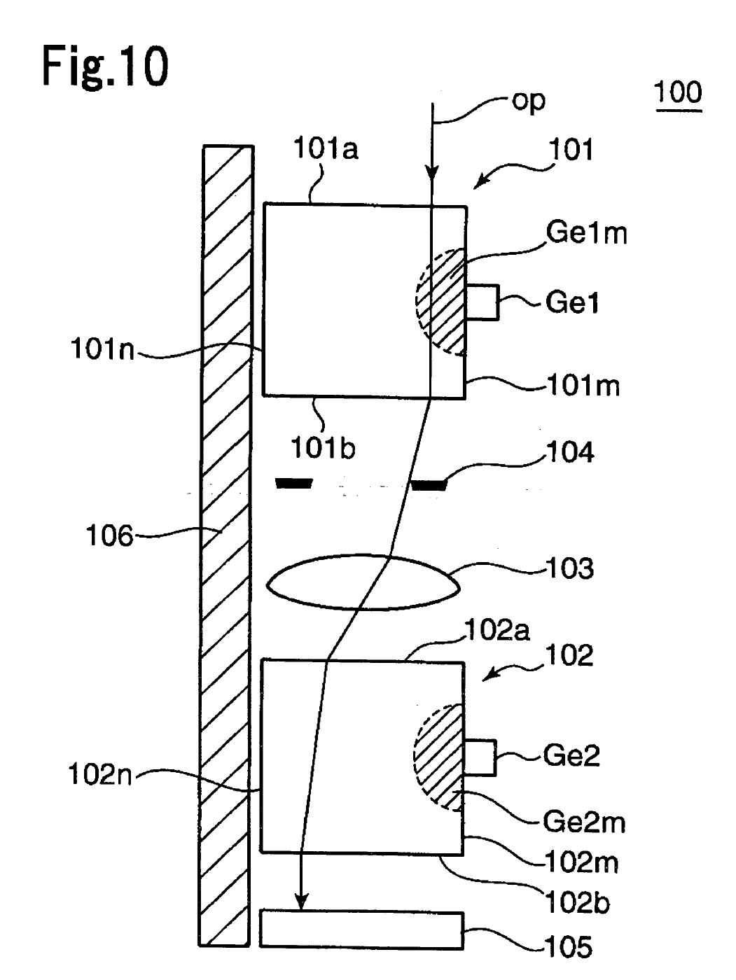

Further, in the case where the optical diaphragm 104 is placed between the incidence-side prism 101 and the image-surface side prism 102 (see FIG. 1), as in the image pickup optical system 100, it is desirable to adjust the orientations of the gates during assembly, such that the gate marks Ge1 and Ge2 on the incidence-side prism 101 and the image-surface side prism 102 exist in the same direction, as illustrated in FIG. 9. This will be described on the basis of FIG. 10.

FIG. 10 is a schematic view of an optical path in the image pickup optical system 100 as illustrated in FIG. 9. As illustrated therein, the gate marks Ge1 and Ge2 on the incidence-side prism 101 and the image-surface side prism 102 are formed on the unused surfaces 101m and 102m which exist in the same direction. Further, since the other unused surfaces 101n and 102n opposite from these unused surfaces 101m and 102m are flat surfaces (surfaces having a stable shape) having no gate marks Ge1 and Ge2 thereon, the unused surfaces 101n and 102n are secured to a prism holding member 106 (corresponding to a frame member or the like of the cabinet BD) which is common to the incidence-side prism 101 and the image-surface side prism 102. This enables assembly of the prisms with high accuracy.

Although the provision of the gate marks Ge1 and Ge2 on the unused surfaces 101m and 102m can alleviate the influences of birefringence and the like, it is difficult to completely eliminate the influences thereof. In FIG. 10, there are illustrated the areas around the gate marks Ge1 and Ge2 which have influences on the optical characteristics, as gate influence areas Ge1m and Ge2m (the hatched portions in the figure).

On the other hand, when the optical diaphragm 104 is placed between the incidence-side prism 101 and the image-surface side prism 102, the optical image is reversed before or after the optical diaphragm 104. Hereinafter, there will be made studies of the optical path of a light ray op entered from the incidence-side surface 101a of the incidence-side prism 101 near the gate mark Ge1. The light ray op is passed through the gate influence area Ge1m within the incidence-side prism 101 and is influenced by birefringence and the like thereby. However, after being passed through the optical diaphragm 104, the light ray op is refracted in the direction away from the gate mark Ge1. Then, the optical ray op enters the image-surface side prism 102 and passes through an area thereof apart from the gate influence area Ge2m. Accordingly, the optical ray op is prevented from being successively passed through the gate influence areas Ge1m and Ge2m of the incidence-side prism 101 and the image-surface side prism 102, which can disperse the influences of residual birefringence, thereby preventing the occurrence of inconvenience such as uneven distribution of the influences of birefringence and the like only at a single side of the screen.

Injection molding methods using resin materials as aforementioned have the advantages of being suitable for mass production and being able to form accurate concave surfaces and the like as the incidence surfaces and the emission surfaces of the reflection prisms. However, the use of a resin material prevents fabrication of reflection prisms having high refractive indexes. Therefore, when there is a need for prisms with high accuracy and high refractive indexes, it is desirable to fabricate prisms through a glass molding method which applies heat and a pressure to a glass material having a high refractive index using a prism-shaped mold. By employing prisms with high refractive indexes, it is possible to reduce the optical-path length and to suppress the occurrence of aberrations at the refraction surfaces, thereby enabling reduction of the size of the image pickup optical system 100 and the number of lenses, which is advantageous to compaction.

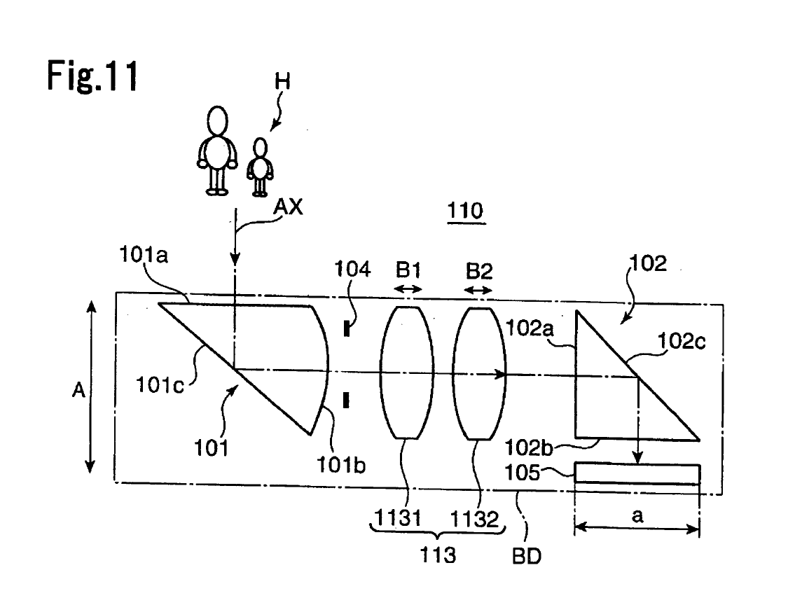

FIG. 11 is a view schematically illustrating the structure of an image pickup optical system according to another embodiment of the present invention. This image pickup optical system is for a variable-power optical system 110 capable of zooming (power-varying) operations. The variable-power optical system 110 is structured to form optical images of an object H on the light receiving surface of an image pickup device 105 which converts the optical images into electrical signals and includes two reflection prisms, namely an incidence-side prism 101 placed near the object H on an optical path and an image-surface side prism 102 placed near the image pickup device 105 on the optical path, similarly to the image pickup optical system 100 previously illustrated in FIG. 1. Further, the variable-power optical system 110 is different from the aforementioned image pickup optical system 100 in that there are placed lenses 113 for power-varying operations and focusing operations, in addition to an optical diaphragm 104, between the incidence-side prism 101 and the image-surface side prism 102.

The aforementioned lenses 113 are constituted by variable-power lenses 1131 and 1132 which are configured to be movable in the directions of arrows B1 and B2 in the figure, respectively. Namely, the aforementioned variable-power lenses 1131 and 1132 are driven in the direction of the optical axis of these lenses (the direction substantially parallel to the incidence surface 101a of the incidence-side prism 101) for performing zooming. This is because, if the entire variable-power optical system including the reflection prisms is structured to be driven in the direction of an optical axis, this will change the thickness of the entire optical system causing problems in reducing the thickness or will increase the weight of to-be-driven members involving an increase of the size of the driving motor. Further, this may cause the problems of the occurrence of deviations of the optical axis due to the aforementioned driving and complication of the mechanism for holding the respective optical devices in the variable-power optical system. By placing the lenses between the two reflection prisms and adapting these lenses to be driven in the direction of the optical axis, it is possible to secure the reflection prisms and the optical diaphragm and, further, it is possible to alleviate the problems of the increase of the size of the driving motor, the occurrence of deviations of the optical axis and the complication of the aforementioned holding mechanism.

In general, in order to perform zooming, there is a need for movement of two groups of lenses for a variator and a compensator. Accordingly, in order to perform preferable power-variation, there is a need for at least two groups of lenses between two prisms and, preferably, the two groups of lenses are moved in the direction of the optical axis. Namely, when they are moved in the direction of the optical axis, the thickness of the optical system is not changed during the varying of the power, which enables realization of a compact variable-power optical system with a small thickness which can be mounted on a cellular phone or a portable information terminal. Further, when the two groups of lenses are movable, it is possible to reduce the distances which the respective groups of lenses should move, in comparison with structures for moving a single group of lenses, which enables compaction of the optical system. However, by properly adjusting the zoom solution as in an optical zoom optical system, it is possible to employ only a single group of lenses movable during power variation.

In the variable-power optical system 110 illustrated in FIG. 11, in order to satisfy the aforementioned requirement, the variable-power lenses 1131 and 1132 are placed between the incidence-side prism 101 and the image-surface side prism 102. Namely, the variable-power optical system 110 is structured to move these variable-power lenses 1131 and 1132 in the direction parallel to the incidence surface 101a of the incidence side prism 101 (the directions of the arrows B1 and B2 in the figure) for performing zooming.

In the variable-power optical system 110, similarly to the image pickup optical system 100 previously illustrated in FIG. 1, the incidence-side prism 101 has a convex-shaped emission surface 101b. Further, it is desirable that the aforementioned formulas (1) and (2) are satisfied. Further, the aforementioned placement of gate marks on the reflection prisms and the aforementioned preferable optical placement (the optical power and the like provided to the reflection prisms) can be similarly applied to the variable-power optical system 110.

[Description of Digital Apparatuses Incorporating an Image Pickup Optical System]

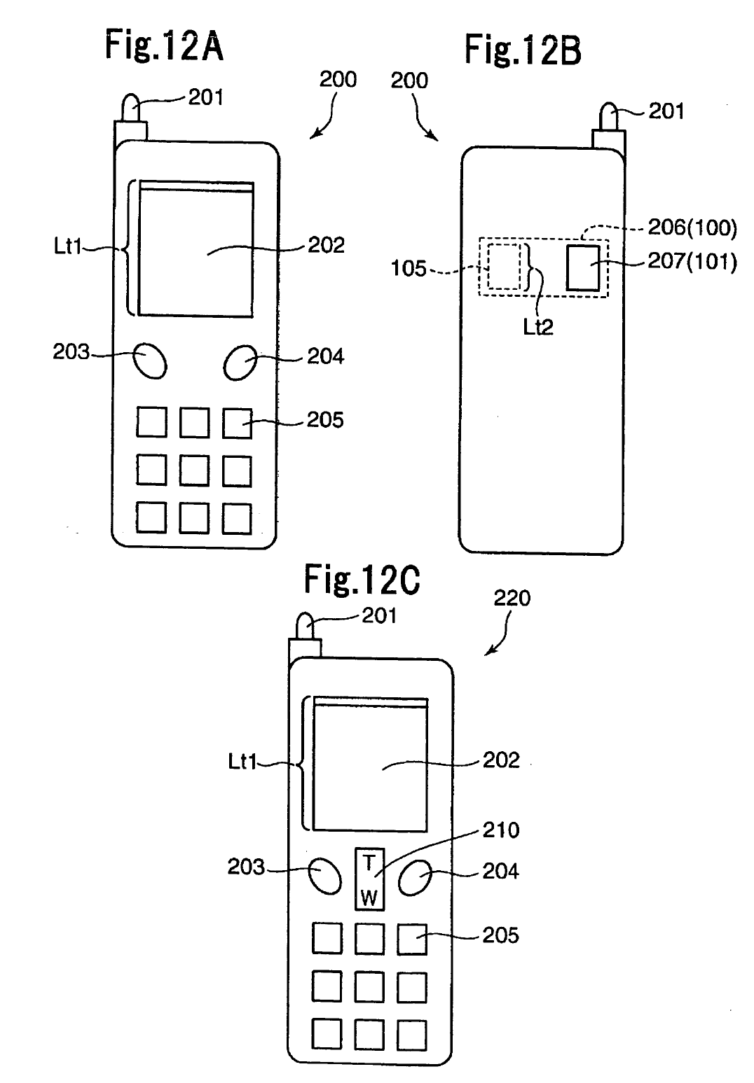

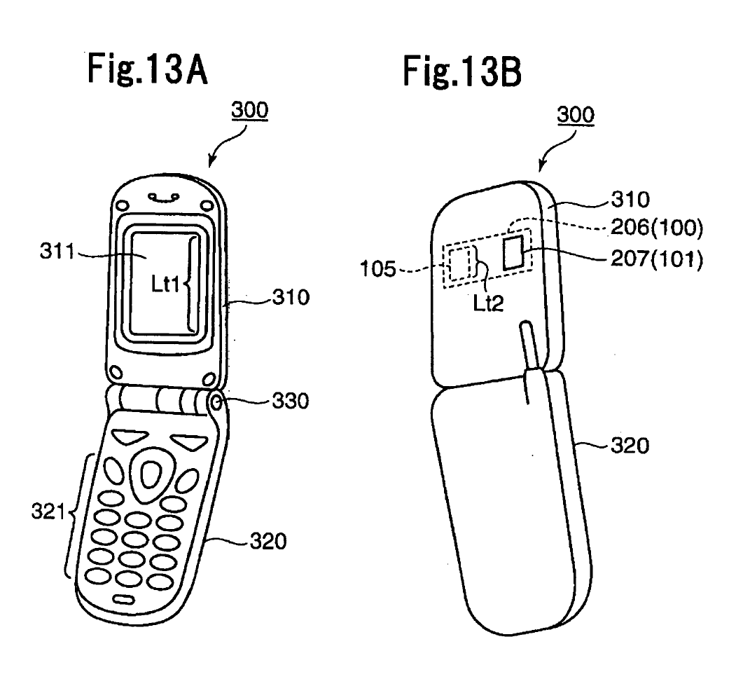

Next, there will be described digital apparatuses incorporating an image pickup optical system 100 (a variable-power optical system 110) as described above. FIGS. 12A to 13C are views of the external structure of a camera-equipped cellular phone 200 (220) illustrating an embodiment of a digital apparatus according to the present invention. In the present invention, digital apparatuses include digital still cameras, video cameras, digital video units, portable information terminals (PDAs: Personal Digital Assistants), personal computers, movable computers and peripheral apparatuses therefore (mouse, scanners, printers and the like). Digital still cameras and digital video cameras are image pickup apparatuses which optically capture images of an object, then convert the images into electrical signals with semiconductor devices and store the electrical signals as digital data in a recording medium such as a flash memory. Further, the present invention includes cellular phones, portable information terminals, personal computers, movable computers and peripheral apparatuses therefore which are designed to incorporate a compact image pickup apparatus for optically capturing still images or moving images of an object.

FIG. 12A illustrates an operation surface of a cellular phone 200, and FIG. 12B illustrates the surface opposite from the operation surface, namely the back surface. The cellular phone 200 includes an antenna 201 at its upper portion, a rectangular-shaped display 202 having longer sides Lt1 extending in the vertical direction in the figure, on the operation surface, an image switching button 203 for activating an image photographing mode and for switching between still-image photographing and moving-image photographing, a shutter button 204 and dial buttons 205.

As illustrated in FIG. 12C, in the case of a cellular phone 220 incorporating a variable-power optical system, the cellular phone 220 includes, on its operation surface, a power-varying button 210 for controlling the power-varying (zooming). The power-varying button 210 is constituted by a two-contact-point type switch or the like having a character of “T” indicating “Telephoto” and a character of “W” indicating “Wide Angle” which are printed at its upper and lower end portions, respectively, to enable providing instructions for respective power-varying operations by pushing the character-printed positions.

The cellular phone 200 incorporates an image pickup apparatus (camera) 206 and an image pickup device 105 such as a CCD which are constituted by an image pickup optical system 100 according to the present invention, wherein a photographing lens 207 for receiving object light in the image pickup apparatus 206 is exposed at the back surface. Further, the incidence surface 101a of an incidence-side prism 101 is placed near the back surface of the photographing lens 207. Namely, the object-light incidence surface of the image pickup apparatus 206 and the display 202 are placed at the rear and front surfaces (the back surface and the operation surface) of the cellular phone 200, respectively. This enables displaying, on the display 202, images captured by the image pickup apparatus 206 during capturing images.

In this case, the image pickup device 105 has a rectangular-shaped image pickup area having a length-to-width ratio of 4:3, for example. Image pickup devices of common types generally have such rectangular shapes, and the image pickup apparatus 206 including the image pickup device 105 is preferably incorporated in the cellular phone 200 in such a manner as illustrated in FIGS. 12A to 12C, with respect to the aforementioned rectangular-shaped display 202.

Namely, in the case where the display 202 has longer sides Lt1 in the vertical direction in FIG. 12A, it is desirable that the image pickup device 105 is incorporated such that its longer sides Lt2 also extend in the vertical direction in FIG. 12B. In other words, it is desirable that the display 202 and the image pickup device 105 are assembled such that the longer sides Lt1 of the display 202 and the longer sides Lt2 of the image pickup device 105 are parallel to each other (oriented in the same direction). This enables the rectangular-shaped display 202 to effectively display the optical images of the object entered to the photographing lens 207 and then formed on the image pickup device 105 having the rectangular-shaped image pickup are.

Namely, when the display 202 and the image pickup device 105 are placed such that the longer sides Lt1 of the display 202 and the longer sides Lt2 of the image pickup device 105 are parallel to each other, the direction of the longer sides of images captured by the image pickup device 105 is coincident with the direction of the longer sides of displayed images, which enables the display 202 to effectively utilize its display area for displaying images, thereby displaying larger images. Namely, it is possible to maximally utilize the area of the display 202 for displaying images, which is advantageous in checking the composition of images during photographing. This applies to the cellular phone 220 incorporating the variable-power optical system illustrated in FIG. 12C.

The aforementioned image pickup apparatus 206 may include a surface parallel plate corresponding to an optical low-pass filter, in addition to the image pickup optical system 100 for forming optical images of an object. As an optical low-pass filter, it is also possible to employ a birefringence-type low-pass filter made of quartz crystal having a predetermined crystal axis adjusted in direction, a phase type low-pass filter capable of realizing required optical cutoff-frequency characteristics utilizing diffraction effects, and the like.

Also, it is not essential that the image pickup apparatus 206 includes an optical low-pass filter. Also, the image pickup apparatus 206 may incorporate an infrared-radiation cutting filter for reducing noises included in image signals from the image pickup device 105, instead of an optical low-pass filter (in this case, it is desirable that the reflection prisms have an infrared-radiation cutting function as previously described). Also, an infrared-radiation reflection coating may be applied to the surface of the optical low-pass filter to realize both the filtering functions with a single filter.

There will be described photographing operations using the cellular phone 200 having the aforementioned structure. In the case of capturing a still image, the image switching button 203 is pushed at first to activate the image photographing mode. In this case, the image switching button 203 is pushed again to switch the image photographing mode to a still-image photographing mode. When the still-image photographing mode is being activated, an image of an object is periodically and repeatedly captured by the image pickup device 105 such as a CCD through the image pickup apparatus 206, then is transferred to a memory for displaying and then is directed to the display 202. It is possible to adjust the position of a main object within the screen such that it exists at a desired position therein, by looking the display 202. By pushing the shutter button 204 at this state, it is possible to capture a still image thereof. Namely, image data thereof is stored in a memory for still images.

In the case of capturing a moving image, the image switching button 203 is pushed once to activate the still-image photographing mode and, then, the image switching button 203 is pushed again to switch the mode to the moving-image photographing mode. Thereafter, similarly to the case of capturing of a still image, the position of the object image acquired through the image pickup apparatus 206 in the screen is adjusted such that it exists at a desired position therein, by looking the display 202. The shutter button 204 is pushed at this state to start capturing a moving image. Then, the shutter button 204 is pushed again to end the capturing of the moving image. The moving image is directed to the display memory for the display 202 and is also directed to a memory for moving images and stored therein.

On the other hand, in the case of the cellular phone 220 incorporating the variable-power optical system illustrated in FIG. 12C, when zoom photographing is performed in order to photograph an object distant from the photographer or an object close to the photographer in an enlarged manner, if the upper-end portion of the power-varying button 210 having the character “T” printed thereon is pushed, then this state is detected, and the power-varying lenses are driven according to the time during which the power-varying button 210 is kept pushed to perform continuous zooming. Also, when it is required to reduce the magnifying power for the object such as when over-zooming has been performed, if the lower end portion of the power-varying button 210 having the character “W” printed thereon is pushed, then this state is detected and the power is continuously varied according to the time during which the power-varying button 210 is kept pushed. As described above, even for an object distant from the photographer, it is possible to adjust the magnifying power using the power varying button 210. Then, similarly to normal photographing at the same magnification, the position of a main object within the screen is adjusted such that it exists at a desired position therein, and then the shutter button 204 is pushed to capture an enlarged still image thereof.

Further, in the case of capturing a moving image, similarly, the magnification power for the object image can be adjusted using the power-varying button 210. Namely, after the shutter button 204 is pushed to start capturing of a moving image, the magnification power for the object can be changed using the power-varying button 210 as required, during capturing the moving image. At this state, the shutter button 204 is pushed again to end the capturing of the moving image.

Also, the power-varying button 210 in the cellular phone 220 is not limited to that in the aforementioned embodiment, and it is possible to utilize the existing dial buttons 205 instead thereof. In an alternative aspect, the cellular phone 220 may have the function of varying the power in both the zoom-in and zoom-out directions, such as a rotation-type dial having a rotation shaft provided on the dial-button-installed surface.

While, in the aforementioned embodiment, the longer sides Lt1 of the display 202 and the longer sides Lt2 of the image pickup device 105 are aligned in the vertical direction in FIG. 8 in parallel to each other, the present invention is not limited thereto, and it is desirable that they are aligned in a single direction such as the horizontal direction in FIG. 8 in parallel to each other. In this case, similarly, it is possible to maximally utilize the area of the display 202 for displaying images, which enables effectively checking the compositions of images and the like during photographing.

The aforementioned facts apply to various types of digital apparatuses including a display as a displaying device such as, for example, foldable-type cellular phones, digital still cameras; digital video cameras, portable information terminals, personal computers, movable computers and peripheral apparatuses therefore, as well as the aforementioned cellular phone 200 (220).

FIG. 13 is a view of the external structural of a foldable-type cellular phone 300. FIG. 13A illustrates an operation surface of the cellular phone 300, and FIG. 13B illustrates the surface opposite from the operation surface, namely the rear surface. The cellular phone 300 has a foldable structure constituted by a first cabinet 310, a second cabinet 320 and a hinge 330 coupling the first and second cabinets 310 and 320 to each other, wherein the first cabinet 310 includes a display 311 having a greater length in the vertical direction, on its operation surface, and the second cabinet 320 includes a key inputting portion 321 as an operating portion.

In the aforementioned cellular phone 300, the first cabinet 310 incorporates an image pickup apparatus 206 and an image pickup device 105 which are constituted by an image pickup optical system 100 (or a variable-power optical system 110) as previously described, and a photographing lens 207 in the image pickup apparatus 206 is exposed at the rear surface. Namely, the object-light incidence surface of the image pickup apparatus 206 and the display 311 are placed on the back and front surfaces (the back surface and the operation surface) of the first cabinet 310, respectively. This enables displaying, on the display 311, the images captured by the image pickup apparatus 206 during capturing images. Further, the display 311 and the image pickup device 105 are assembled such that the longer sides Lt1 of the display 311 and the longer sides Lt2 of the image pickup device 105 are parallel to each other (oriented in the same direction). This enables the rectangular-shaped display 311 to effectively display optical images of the object entered to the photographing lens 207 and then formed on the image pickup device 105 having the rectangular-shaped image pickup area.

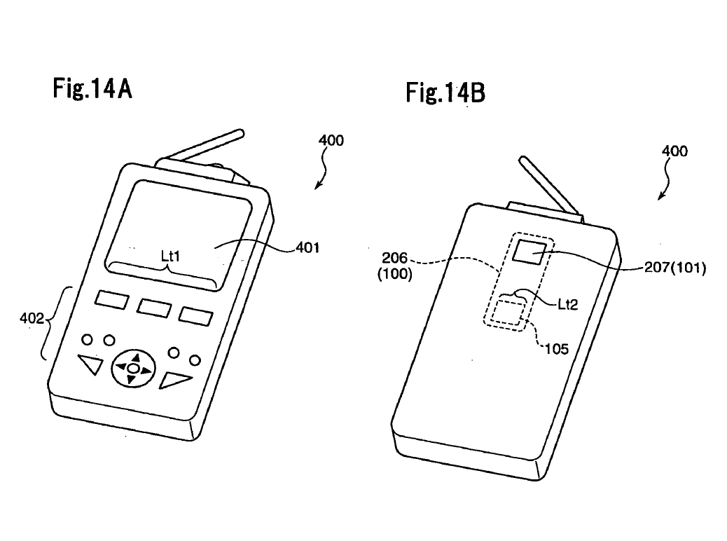

FIGS. 14A and 14B are views of the external structure of a portable information terminal 400. FIG. 14A illustrates an operation surface of the portable information terminal 400, and FIG. 14B illustrates the rear surface thereof. The portable information terminal 400 includes a display 401 having a greater length in the horizontal direction and a key inputting portion 402 as an operating portion, on the operation surface thereof.

The aforementioned portable information terminal 400 incorporates an image pickup apparatus 206 and an image pickup device 105 which are constituted by an image pickup optical system 100 (or a variable-power optical system 110) as previously described, and a photographing lens 207 in the image pickup apparatus 206 is exposed at the rear surface. Namely, the object-light incidence surface of the image pickup apparatus 206 and the display 401 are placed on the rear and front surfaces (the back surface and the operation surface) of the portable information terminal 400, respectively. This enables displaying, on the display 401, the images captured by the image pickup apparatus 206, during capturing images. Further, the display 401 and the image pickup device 105 are assembled such that the longer sides Lt1 of the display 401 and the longer sides Lt2 of the image pickup device 105 are parallel to each other (oriented in the horizontal direction, in this case). This structure enables the rectangular-shaped display 401 to effectively display optical images of the object entered to the photographing lens 207 and then formed on the image pickup device 105 having the rectangular-shaped image pickup area.

Hereinafter, in the present specification, the terms “concave”, “convex” and “meniscus” will be used with respect to lenses, and these terms will designate the shapes of lenses around their optical axes (around the centers of the lenses), not the shapes of the entire lenses or the near-end portions of the lenses. This does not matter in cases of spherical lenses. However, in cases of aspherical lenses, generally, the shape of the near-center portion is different from the shape of the near-end portion and, therefore, attentions should be paid thereon. Aspherical lenses are lenses having parabolic surfaces, elliptical surfaces, hyperbolic surfaces, quartic surfaces and the like.

Further, in the present specification, the optical power of each single lens constituting a single lens or a compound lens designates the power of the single lens when the single lens has interfaces with air at its opposite lens surfaces, namely when the single lens exists alone.

[Description of Concrete Embodiments of the Image Pickup Optical System]

Hereinafter, with reference to the drawings, there will be described the concrete structure of the image pickup optical system 100 illustrated in FIG. 1, namely the image pickup optical system 100 constituting the image pickup apparatus 206 mounted on the camera-equipped cellular phone 200 or 300 or the portable information terminal 400 illustrated in FIGS. 12 to 14.

### First Embodiment

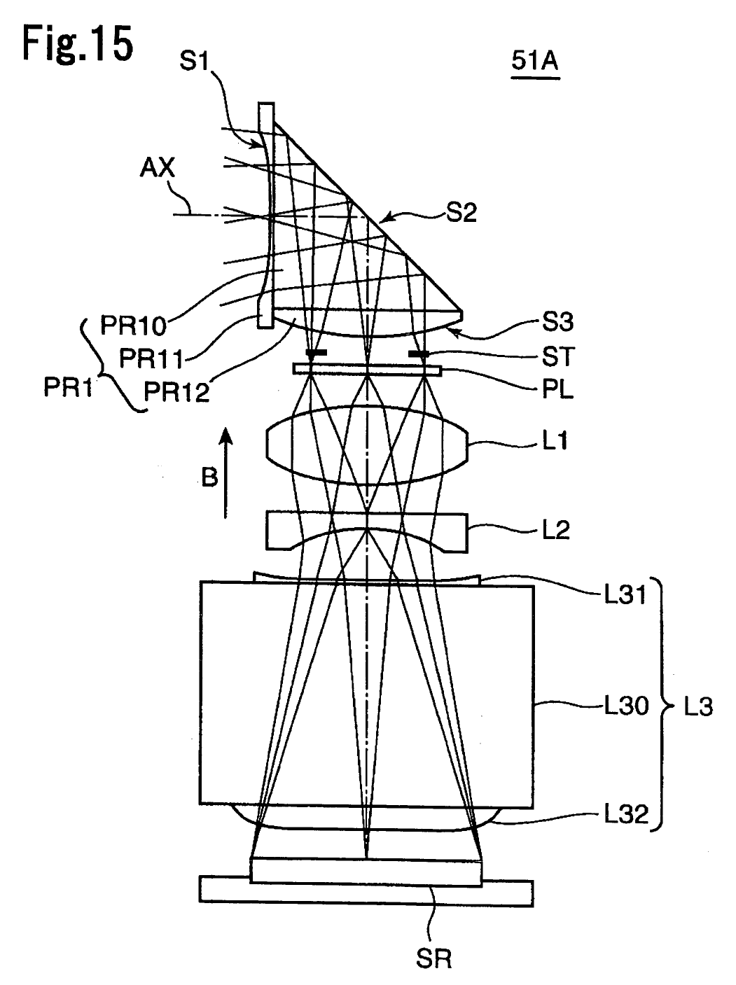

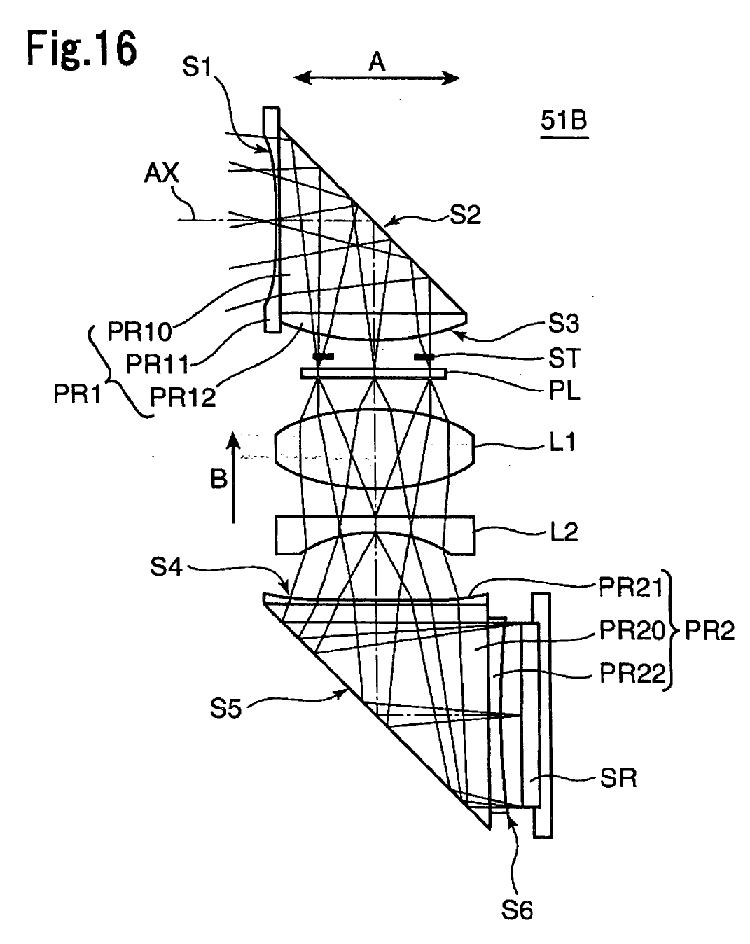

FIG. 15 is a longitudinal cross-sectional view illustrating the structure of an image pickup optical system 51A according to a first embodiment, taken along an optical axis (AX). FIG. 15 illustrates the placement of optical devices at a state where they are focused at infinity. In FIG. 15 (FIGS. 16 to 29), there is further illustrated the general outline of the path of light incident from an object, and the center line of the optical path is the optical axis (AX).

The image pickup optical system 51A according to the present embodiment is structured to include a first reflection prism of a compound type having positive optical power in its entirety (PR1; corresponding to the incidence-side prism 101 in FIG. 1), a first lens (L1) formed from a double-convex positive lens (a lens having positive optical power), a second lens (L2) formed from a positive meniscus lens which is convex at its object side, and a third lens (L3) formed from a compound lens having positive optical power in its entirety. Further, an optical diaphragm (ST) and a surface parallel plate (PL) are placed between the aforementioned first reflection prism (PR1) and the first lens (L1). Further, an image pickup device (SR) is placed near the image side of the third lens (L3). The image pickup device (SR) is an image pickup device having a length-to-width ratio of 3:4, for example.

The aforementioned first reflection prism (PR1) has an incidence surface (S1) having negative optical power, an emission surface (S3) having positive optical power and a flat-surface shaped reflection surface (S2) on the optical path between the incidence surface (S1) and the emission surface (S3). Namely, the first reflection prism (PR1) is made of a prism (P10) having a flat incidence surface (S1) and a flat emission surface (S3), a concave lens (PR11) bonded to the incidence surface (S1) and a convex lens (PR12) bonded to the emission surface (S3). Further, the third lens (L3) is made of an optical device (L30) having flat surfaces at its opposite sides, a concave lens (L31) bonded to the incidence surface of the optical device (L30) and a concave lens (L32) bonded to the emission surface of the optical device (L30). The image pickup optical system 51A is structured to fold incidence light by about 90 degree at the first reflection prism (PR1) and direct it to the image pickup device (SR).

On the other hand, FIG. 16 is a longitudinal cross-sectional view illustrating the structure of another image pickup optical system 51B according to the first embodiment, taken along an optical axis (AX). The image pickup optical system 51B employs a second reflection prism of a compound type (PR2: corresponding to the image-surface side prism 102 in FIG. 1) having optical characteristics equivalent to those of the compound lens (L3), instead of the third lens (L3) in the aforementioned image pickup optical system 51A. The second reflection prism (PR2) has an incidence surface (S4) having negative optical power, an emission surface (S6) having negative optical power and a flat-shaped reflection surface (S5) on the optical path between the incidence surface (S4) and the emission surface (S6). Further, the second reflection prism (PR2) is made of a prism (P10) having a flat incidence surface (S4) and a flat emission surface (S6), a concave lens (PR11) bonded to the incidence surface (S4) and a convex lens (PR12) bonded to the emission surface (S6).

The image pickup optical system 51B is structured to fold incident light by about 90 degree at the first reflection prism (PR1), then fold it by about 90 degree at the second reflection prism (PR2) and direct it to the image pickup device (SR). The direction of an arrow A illustrated in the figure corresponds to the thicknesswise direction of the cellular phone 200 illustrated in FIG. 12.

The first reflection prism (PR1), the third lens (L3) or the second reflection prism (PR2) and the optical diaphragm (ST) are secured and, in focusing from an infinity focusing state to a vicinity focusing state, the first and second lenses (L1 and L2) are moved in the direction of an arrow B in FIGS. 15 and 16.

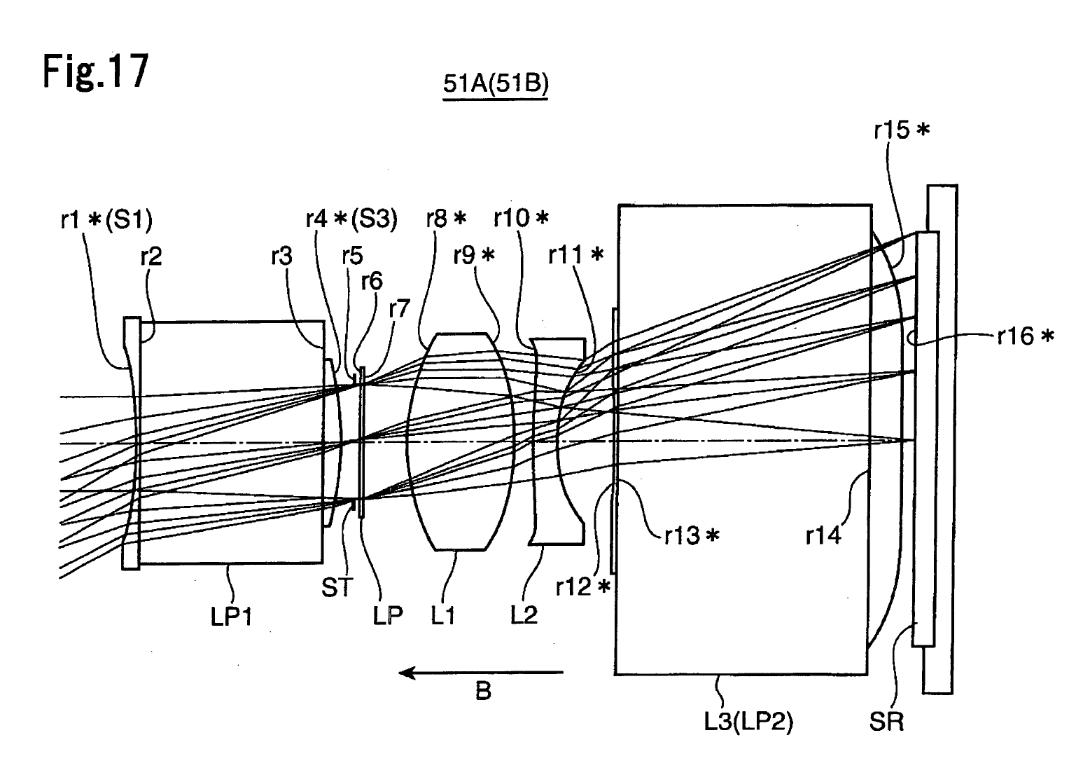

FIG. 17 is a view illustrating the structure of an image pickup optical system 51A (51B) structured by replacing the first reflection prism (PR1) in FIG. 15 and the first reflection prism (PR1) and the second reflection prism (PR2) in FIG. 16, with lenses (LP1 and LP2) having functions substantially equal to those of these reflection prisms. The numbers ri (i=1, 2, 3, . . . ) illustrated in FIG. 17 designate i-th lens surfaces countered from the object side, and a mark of * attached to the numbers ri indicate an aspherical surface. Further, the number of the lenses constituting a compound lens designates the number of single lenses constituting the compound lens, and the entire compound lens is not regarded as a single lens. For example, the number of lenses in a compound lens constituted by three single lenses is designated as three, not one.

In the image pickup optical system 51A illustrated in FIG. 15 having the aforementioned structure, a light ray incident from the object (the photographic object) in FIG. 17 enters the incidence surface S1 of the first reflection prism (PR1), then is reflected by the reflection surface S2 while being folded by about 90 degree, then is successively passed through the surface parallel plate (PL), the first lens (L1), the second lens (L2) and the third lens (L3) and forms an optical image on the image pickup surface of the image pickup device (SR). The aforementioned surface parallel plate (PL) corresponds to an optical low-pass filter, an infrared-radiation cutting filter, a cover glass on the image pickup device, and the like. On the other hand, in the image pickup optical system 51B illustrated in FIG. 16, the incident light passed through the second lens (L2) enters the incidence surface S4 of the second reflection prism (PR2), then is reflected by the reflection surface S5 thereof while being folded by about 90 degree, then is emitted from the emission surface S6 and forms an optical image on the image pickup surface of the image pickup device (SR).

Then, the image pickup device (SR) converts the optical image into electrical signals. The electrical signals are subjected to predetermined image digital image processing and image compression processing as required and then are recorded as digital image signals in a memory in the cellular phone 200 or 300 or the portable information terminal device 400 illustrated in FIGS. 12 to 14 or transmitted to other digital apparatuses through wired or wireless communication. Further, in order to prevent damages and contaminations of the image pickup optical system, particularly the first reflection prism (PR1), a cover glass may be provided between the incidence surface of the first reflection prism (PR1) and the object.

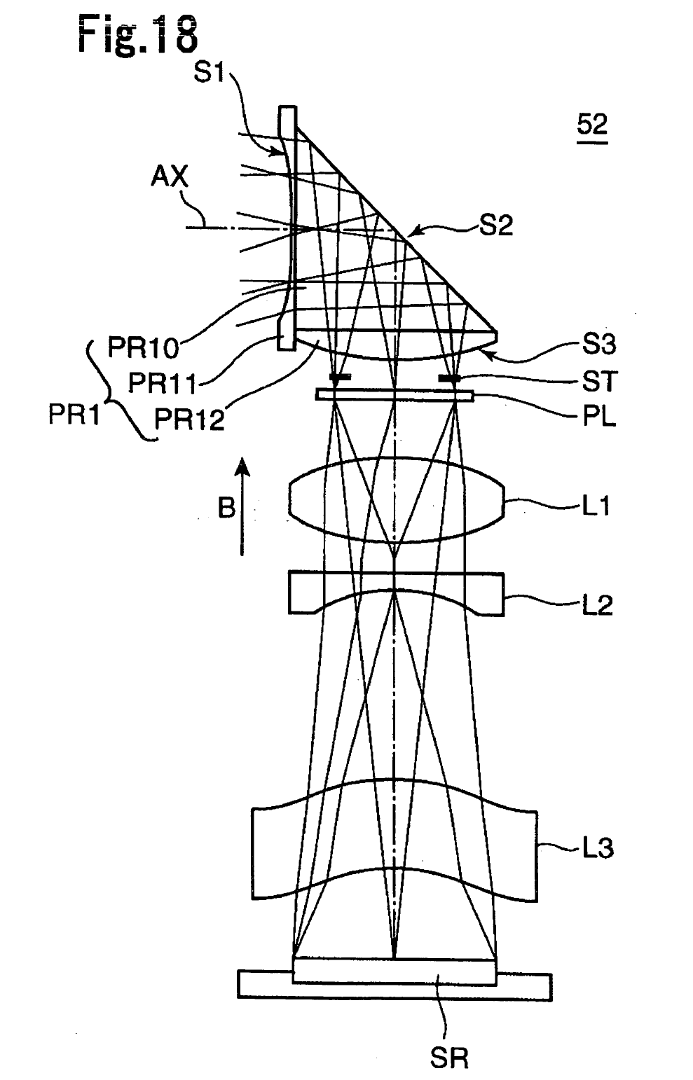

Hereinafter, with reference to the drawings, there will be described the lens structures according to a second and other embodiments, in order, similarly to the first embodiment. In FIG. 18 and the other figures, the same reference characters as those in FIGS. 15 to 17 designates similar components in FIGS. 15 to 17. However, the same reference characters designate similar components, not completely identical components. For example, although the first reflection prisms in FIGS. 15 to 18 are designated by the same reference character (PR1), these first reflection prisms are not intended to be identical.

### Second Embodiment

FIG. 18 is a longitudinal cross-sectional view illustrating the structure of an image pickup optical system 52 according to a second embodiment, taken along an optical axis (AX). The image pickup optical system 52 according to the second embodiment is structured to include a first reflection prism (PR1) having positive optical power in its entirety, an optical diaphragm (ST) for adjusting the light quantity, a plane parallel plate (PL), a first lens (L1) made of a double-convex positive lens, a second lens (L2) made of a positive meniscus lens having a convex surface at its object side, and a third lens (L3) made of a positive meniscus lens having a convex surface at its object side. Further, an image pickup device (SR) is placed near the image side of the third lens (L3).

The first reflection prism (PR1) has an emission surface (S1) having negative optical power, an emission surface (S3) having positive optical power, and a flat-shaped reflection surface (S2) on the optical path between the incidence surface (S1) and the emission surface (S3). Namely, the first reflection prism (PR1) is made of a prism (P10) having a flat-shaped incidence surface (S1) and a flat-shaped emission surface (S3), a concave lens (PR11) bonded to the incidence surface (S1) and a convex lens (PR12) bonded to the emission surface (S3). The image pickup optical system 52 is structured to fold incident light by about 90 degree at the first reflection prism (PR1) and direct it to the image pickup device (SR), similarly to the image pickup optical system 51A illustrated in FIG. 15.

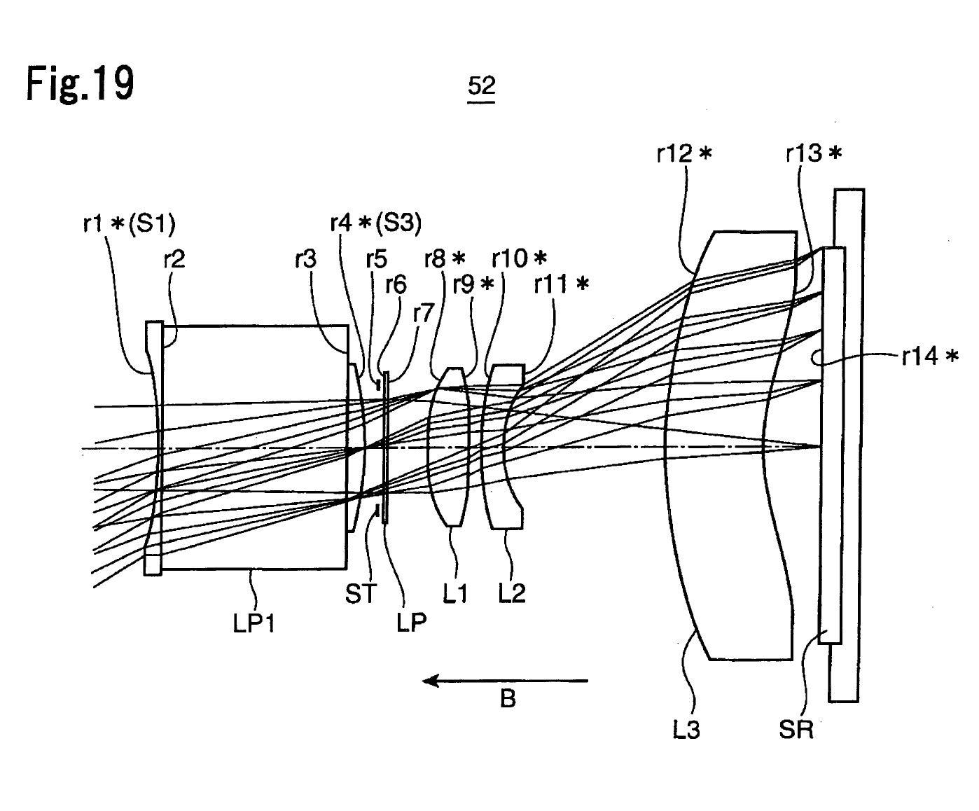

The first reflection prism (PR1), the third lens (L3) and the optical diaphragm (ST) are secured and, in focusing from an infinity focusing state to a vicinity focusing state, the first and second lenses (L1 and L2) are moved in the direction of an arrow B in FIG. 18. FIG. 19 is a view illustrating the structure of an image pickup optical system 52 structured by replacing the first reflection prism (PR1) in FIG. 18 with a lens (LP1) having functions substantially equal to those of this reflection prism.

### Third Embodiment

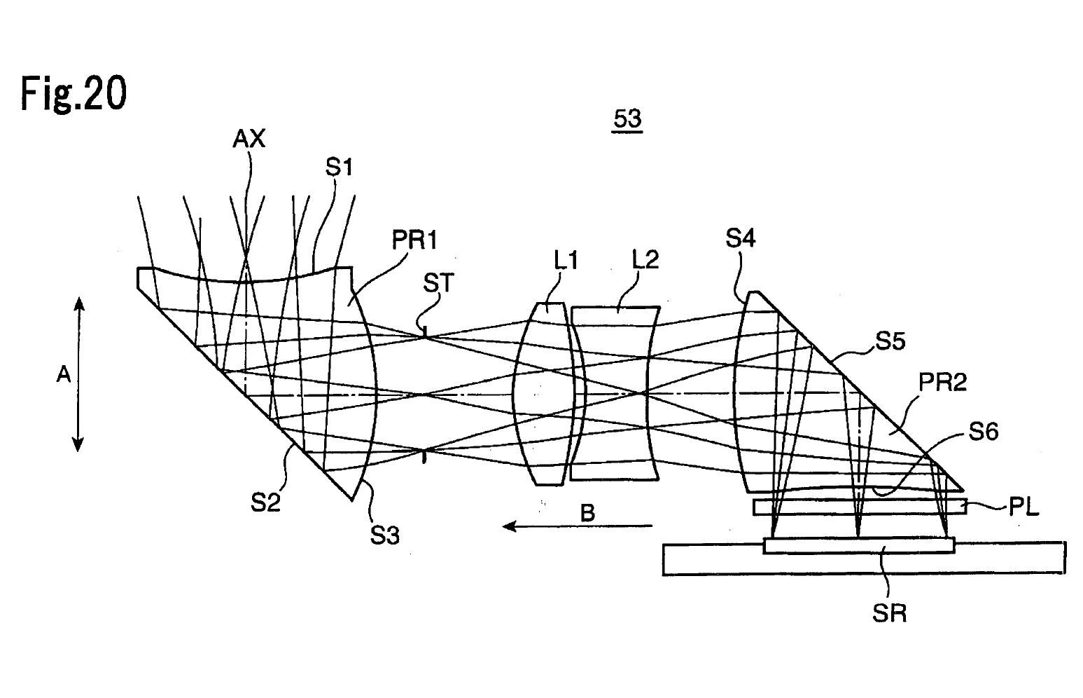

FIG. 20 is a longitudinal cross-sectional view illustrating the structure of an image pickup optical system 53 according to a third embodiment, taken along an optical axis (AX). The image pickup optical system 53 according to the third embodiment is structured to include a first reflection prism (PR1) having positive optical power in its entirety, an optical diaphragm (ST) for adjusting the light quantity, a first lens (L1) made of a double-convex positive lens, a second lens (L2) made of a double-concave negative lens, and a second reflection prism (PR2) having positive optical power in its entirety. Further, a plane parallel plate (PL) and an image pickup device (SR) are placed near the emission surface of the second reflection prism (PR2).

The first reflection prism (PR1) has an incidence surface S1 having negative optical power, an emission surface S3 having positive optical power, and a flat-shaped reflection surface S2 on the optical path between the incidence surface S1 and the emission surface S3. The second reflection prism (PR2) has an incidence surface S4 having positive optical power, an emission surface S6 having negative optical power, and a flat-shaped reflection surface S5 on the optical path between the incidence surface S4 and the emission surface S6. The reflection surfaces S2 and S5 provided in the first reflection prism (PR1) and the second reflection prism (PR2) fold the incident light by about 90 degree and reflect it toward the first lens (L1) or the plane parallel plate (PL).

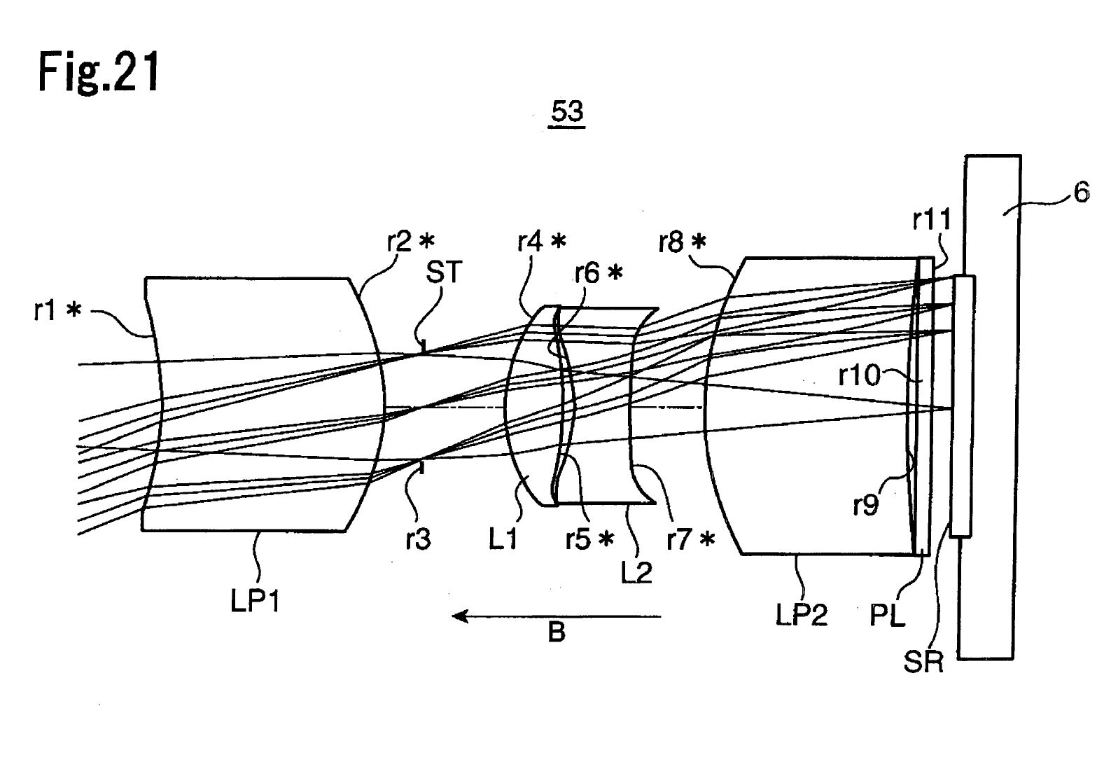

The first and second reflection prisms (PR1 and PR2) and the optical diaphragm (ST) are secured and, in focusing from an infinity focusing state to a vicinity focusing state, the first and second lenses (L1 and L2) are moved in the direction of an arrow B in FIG. 20. FIG. 21 illustrates the structure of an image pickup optical system 53 structured by replacing the first and second reflection prisms (PR1 and PR2) in FIG. 20, with lenses (LP1 and LP2) having functions substantially equal to those of the reflection prisms.

### Fourth Embodiment

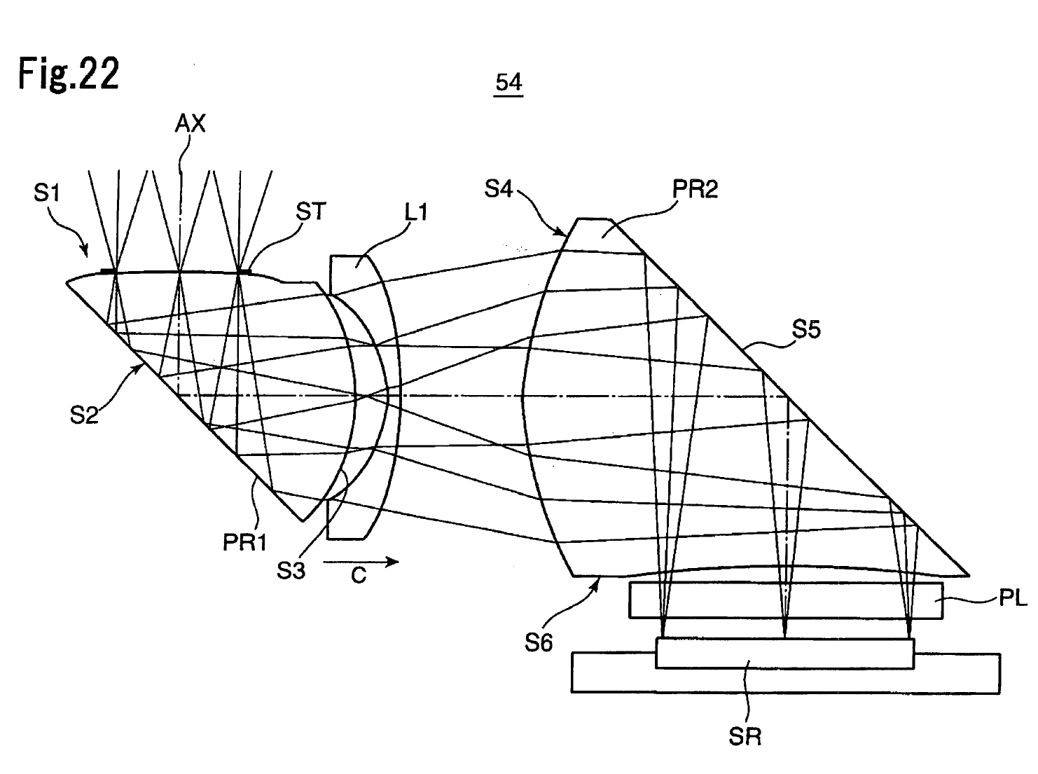

FIG. 22 is a longitudinal cross-sectional view illustrating the structure of an image pickup optical system 54 according to a fourth embodiment, taken along an optical axis (AX). The image pickup optical system 54 according to the fourth embodiment is structured to include an optical diaphragm (ST) for adjusting the optical quantity, a first reflection prism (PR1) having positive optical power in its entirety, a first lens (L1) made of a negative meniscus lens having a convex surface at its object side, and a second lens (L2) having positive optical power in its entirety.

The first reflection prism (PR1) has an incidence surface S1 having positive optical power, an emission surface S3 having positive optical power, and a flat-shaped reflection surface S2 on the optical path between the incidence surface S1 and the emission surface S3. The second reflection prism (PR2) has an incidence surface S4 having positive optical power, an emission surface S6 having negative optical power, and a flat-shaped reflection surface S5 on the optical path between the incidence surface S4 and the emission surface S6. The reflection surfaces S2 and S5 provided in the first reflection prism (PR1) and the second reflection prism (PR2) fold the incident light by about 90 degree and reflect it toward the first lens (L1) or the plane parallel plate (PL).

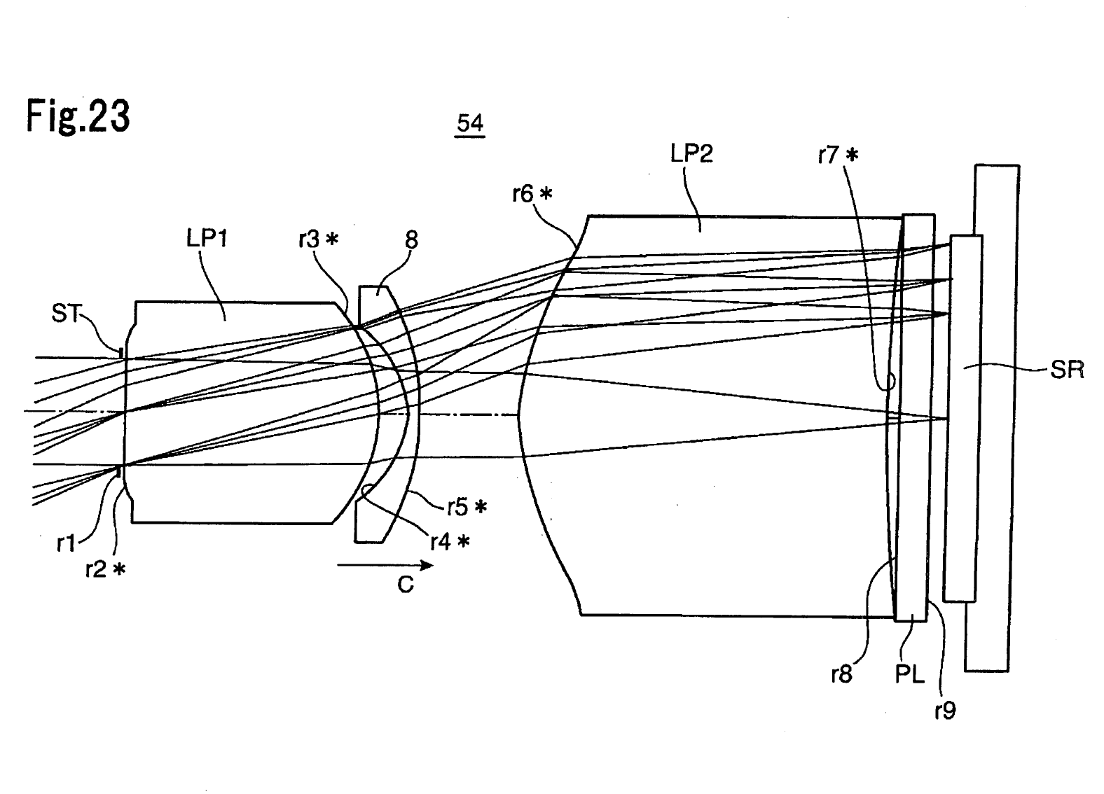

The optical diaphragm (ST) and the first and second reflection prisms (PR1 and PR2) are secured and, in focusing from an infinity focusing state to a vicinity focusing state, the first lens (L1) is moved in the direction of an arrow C in FIG. 22. FIG. 23 illustrates the structure of an image pickup optical system 54 structured by replacing the first and second reflection prisms (PR1 and PR2) in FIG. 22, with lenses (LP1 and LP2) having functions substantially equal to those of the reflection prisms.

### Fifth Embodiment

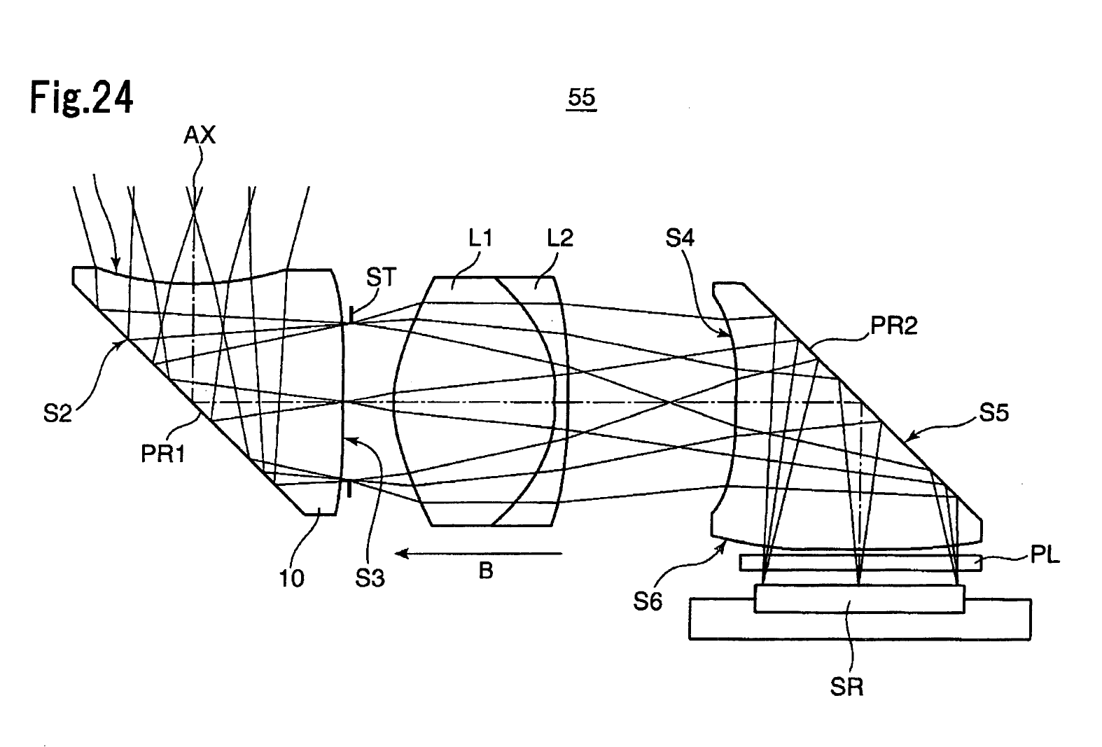

FIG. 24 is a longitudinal cross-sectional view illustrating the structure of an image pickup optical system 55 according to a fifth embodiment, taken along an optical axis (AX). The image pickup optical system 55 according to the fifth embodiment is structured to include a first reflection prism (PR1) having positive optical power in its entirety, an optical diaphragm (ST) for adjusting the optical quantity, a first lens (L1) made of a double-convex positive lens, and a second lens (L2) made of a negative meniscus lens having a convex surface at its object side, and a second reflection prism (PR2) having positive optical power in its entirety. The first lens (L1) and the second lens (L2) are bonded to each other to form a compound lens.

The first reflection prism (PR1) has an incidence surface S1 having negative optical power, an emission surface S3 having positive optical power, and a flat-shaped reflection surface S2 on the optical path between the incidence surface S1 and the emission surface S3. The second reflection prism (PR2) has an incidence surface S4 having positive optical power, an emission surface S6 having negative optical power, and a flat-shaped reflection surface S5 on the optical path between the incidence surface S4 and the emission surface S6. The reflection surfaces S2 and S5 provided in the first reflection prism (PR1) and the second reflection prism (PR2) fold the incident light by about 90 degree and reflect it toward the first lens (L1) or the plane parallel plate (PL).

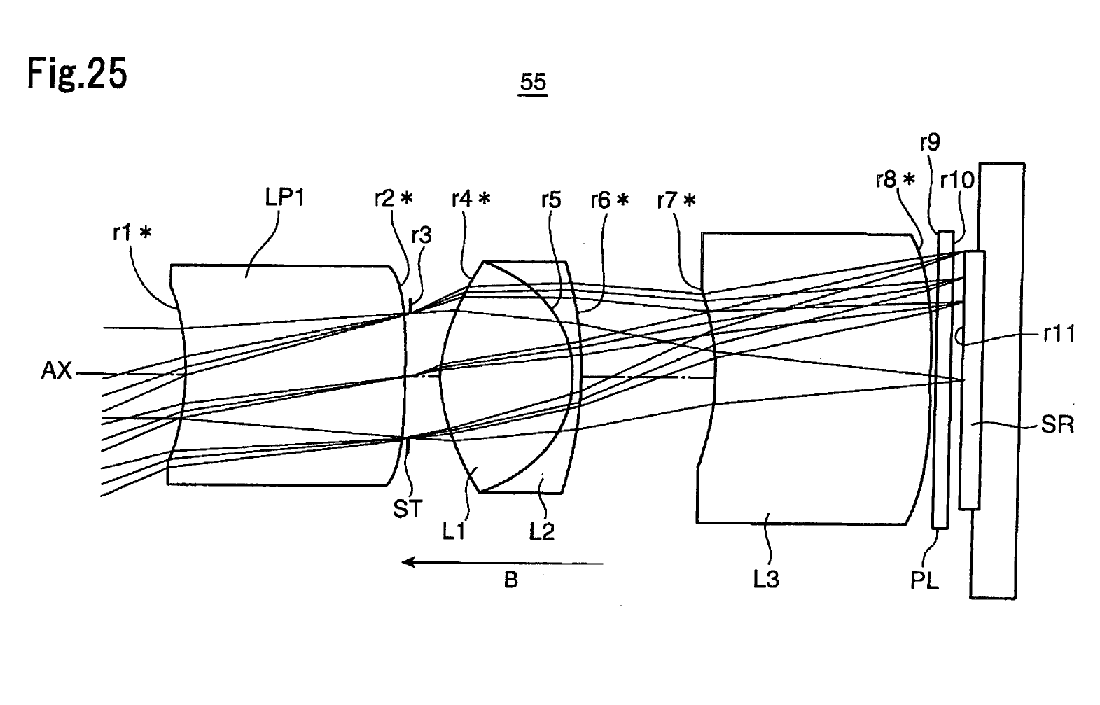

The first and second reflection prisms (PR1 and PR2) and the optical diaphragm (ST) are secured and, in focusing from an infinity focusing state to a vicinity focusing state, the first and second lenses (L1 and L2) are moved in the direction of an arrow B in FIG. 24. FIG. 25 illustrates the structure of an image pickup optical system 55 structured by replacing the first and second reflection prisms (PR1 and PR2) in FIG. 24, with lenses (LP1 and LP2) having functions substantially equal to those of the reflection prisms.

Hereinafter, the image pickup optical systems 51 to 55 according to the aforementioned embodiments will be concretely described, by exemplifying construction (structure) data, aberration diagrams, and the like.

### EXAMPLE 1

Tables 3 and 4 illustrate construction data of the respective lenses in the image pickup optical systems 51A and 51B according to the first embodiment (example 1).

TABLE 3

| | | AXIAL SURFACE | | | |
|---|---|---|---|---|---|
| | | SEPARATION (mm) | | | |
| OPTICAL- | RADIUS OF | INFINITY | VICINITY | | |
| SURFACE | CURVATURE | FOCUSING | FOCUSING | REFRACTIVE | ABBE |
| NUMBER | (mm) | STATE | STATE | INDEX | NUMBER |
| r1* | −6.341 | 0.000 | | 1.53048 | 55.72 |
| r2 | ∞ | 3.953 | | 1.53048 | 55.72 |
| r3 | ∞ | 0.359 | | 1.53048 | 55.72 |
| r4* | −6.442 | 0.300 | | | |
| r5 | ∞ | 0.100 | | | |
| r6 | ∞ | 0.100 | | 1.51680 | 65.26 |
| r7 | ∞ | 0.927 | 0.300 | | |
| r8* | 3.687 | 2.400 | | 1.53048 | 55.72 |
| r9* | −4.355 | 0.398 | | | |
| r10* | 29.872 | 0.500 | | 1.80358 | 25.38 |
| r11* | 2.883 | 1.302 | 1.929 | | |
| r12* | −87.870 | 0.100 | | 1.58340 | 30.23 |
| r13* | ∞ | 5.407 | | 1.58340 | 30.23 |
| r14 | ∞ | 0.704 | | 1.58340 | 30.23 |
| r15* | 56.377 | 0.300 | | | |
| r16 | ∞ | | | | |

TABLE 4

| LENS | | | | | |
|---|---|---|---|---|---|
| SUR- | | ASPHERICITY COEFFICIENT | | | |
| FACE | k | A | B | C | D |
| r1 | 0 | 4.884E−05 | 7.530E−05 | −2.650E−06 | 2.061E−07 |
| r4 | 0 | −5.762E−04 | 4.525E−04 | −5.454E−05 | 5.580E−06 |
| r8 | 0 | −4.876E−03 | 2.679E−04 | −1.198E−04 | 5.588E−06 |
| r9 | 0 | 9.016E−03 | −1.775E−03 | 3.763E−05 | 3.653E−06 |
| r10 | 0 | 6.543E−03 | −1.375E−03 | −3.393E−04 | 2.772E−05 |
| r11 | 0 | 6.762E−04 | 6.065E−04 | −7.414E−04 | 6.073E−05 |
| r12 | 0 | −1.544E−03 | 1.761E−04 | 1.800E−05 | −2.153E−06 |
| r15 | 0 | −1.783E−04 | −2.968E−04 | 1.559E−05 | −2.785E−07 |

FIG. 3 illustrates the respective optical-surface numbers, the radiuses of curvature of the respective surfaces (with a unit of mm), the respective intervals between adjacent optical surfaces at an infinity focusing state and at a vicinity focusing state along an optical axis (the axial surface separations; with a unit of mm), the refractive indexes and the Abbe numbers of the respective lenses, in the mentioned order from the light to the left. The axial surface separations are distances converted on the assumption that air exists through the space between each pair of opposing surfaces (including optical surfaces and the image pickup surface) as a medium. The blanks in the field of the axial surface separation at the vicinity focusing state indicate the same values as those in the field of the infinity focusing state at the left thereof. In this case, the respective optical-surface numbers ri (i=1, 2, 3, . . . ) designate the i-th optical surfaces counted from the object side along the optical path, in an optical-path diagram substantially equal to the optical-path diagrams of FIGS. 15 and 16 as illustrated in FIG. 17, wherein a mark of * attached to the numbers ri indicates aspherical surfaces (refractive optical surfaces having aspherical shapes or surfaces having refracting effects equivalent to those of aspherical surfaces). Further, the optical diaphragm (ST) and the plane parallel plate (PL) have flat surfaces at their opposite sides, and the image pickup device (SR) also has a flat surface at its light receiving surface, and these flat surfaces have radiuses of curvature of infinity.

The aspherical shapes of the optical surfaces are defined by the following equation (4) which uses a local rectangular coordinate system (x, y, z), wherein the vertexes of the surfaces are placed on the origin and the direction from the object to the image pickup device is set to the positive direction along the z axis.

$$\begin{matrix}[ Equation 2 ] & \\ Z = \frac{c \cdot {h}^{2}}{1 + \sqrt{1 - ( 1 + k ) {c}^{2} \cdot {h}^{2}}} + A \cdot {h}^{4} + B \cdot {h}^{6} + C \cdot {h}^{8} + D \cdot {h}^{10} & ( 4 )\end{matrix}$$

z: the amount of displacement at a height h in the direction of z axis (with respect to the vertex of the surface)

h: the height in the direction perpendicular to the z axis (h2=x2+y2)

c: the paraxial curvature (1/the radius-of-curvature)

A, B, C and D: quartic, sextic, octic and decadic asphericity coefficients, respectively

k: the constant of the cone

As can be seen from the aforementioned equation (4), the radiuses of curvature of the aspherical lenses illustrated in Table 3 represent the values of the radiuses of curvature at the portions of the lenses near their surface-vortexes.

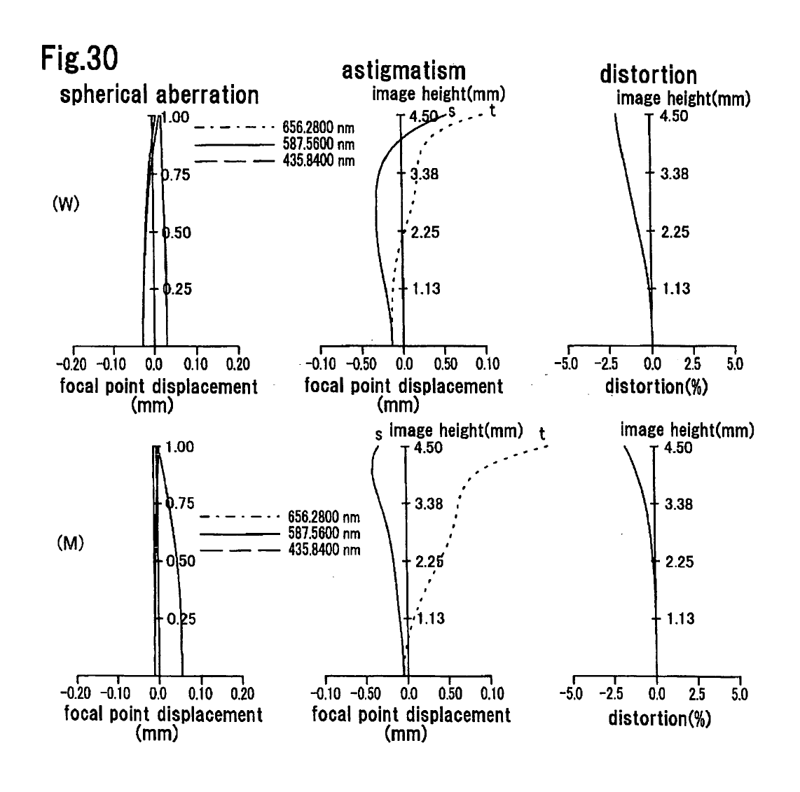

FIG. 30 illustrates, in order from the left to the right, the spherical aberration, the astigmatism and the distortion of the entire optical system according to the example 1 having the aforementioned lens placement and structure. In the figure, there are illustrated, in the upper stage, the spherical aberration, the astigmatism and the distortion at an infinity focusing state and also there are illustrated, in the lower stage, the spherical aberration, the astigmatism and the distortion at a vicinity focusing state. Further, the spherical aberration indicates the deviation of the focus point with a unit of mm. The horizontal axis for the distortion represents the distortion with respect to the entirety with a unit of %. The vertical axis for the spherical aberration represents values standardized with the incidence height, while the vertical axes for the astigmatism and the distortion represent the heights of images (the image height, with a unit of mm).

Further, in the diagrams of the spherical aberration, there are represented the aberrations for three lights with different wavelengths, wherein a broken line represents the aberration for a red light (with a wavelength of 656.28 nm), a solid line represents the aberration for an yellow light (so-called d line; with a wavelength of 587.56 nm) and a two-dot chain line represents the aberration for a blue light (with a wavelength of 435.84 nm). Further, in the diagrams of the astigmatism, a broken line (T) represents the tangential (meridional) image surface in terms of the amount of deviation from the paraxal image surface in the direction of the optical axis (AX) (the horizontal axis, with a unit of mm), while a solid line (S) represents the sagital (radial) image surface in terms of the amount of deviation from the paraxial image surface in the direction of the optical axis (AX) (the horizontal axis, with a unit of mm). Further, the diagrams of the astigmatism and the distortion represent results obtained by using the aforementioned yellow light (d line).

As can be seen from FIG. 30, the image pickup optical systems 51A and 51B according to the present example 1 can sufficiently suppress the spherical aberration, the astigmatism and the distortion, at both the infinity focusing state and the vicinity focusing state, thereby exhibiting excellent optical characteristics. Table 13 represents the focal length (with a unit of mm), the F value and the maximum image height at the infinity focusing state in the present example 1. These tables show that the present invention can realize optical systems with excellent brightness.

### EXAMPLE 2

Tables 5 and 6 illustrate construction data of the respective lenses in the image pickup optical system 52 according to the second embodiment (the example 2).

TABLE 5

| | | AXIAL SURFACE | | | |
|---|---|---|---|---|---|
| | | SEPARATION (mm) | | | |
| OPTICAL- | RADIUS OF | INFINITY | VICINITY | | |
| SURFACE | CURVATURE | FOCUSING | FOCUSING | REFRACTIVE | ABBE |
| NUMBER | (mm) | STATE | STATE | INDEX | NUMBER |
| r1* | −14.584 | 0.000 | | 1.53048 | 55.72 |
| r2 | ∞ | 4.215 | | 1.53048 | 55.72 |
| r3 | ∞ | 0.259 | | 1.53048 | 55.72 |
| r4* | −12.695 | 0.300 | | | |
| r5 | ∞ | 0.100 | | | |
| r6 | ∞ | 0.100 | | 1.51680 | 65.26 |
| r7 | ∞ | 1.087 | 0.300 | | |
| r8* | 3.003 | 0.973 | | 1.53048 | 55.72 |
| r9* | −13.917 | 0.300 | | | |
| r10* | 6.081 | 0.500 | | 1.80358 | 25.38 |
| r11* | 2.628 | 3.667 | 4.454 | | |
| r12* | 7.126 | 2.222 | | 1.58340 | 30.23 |
| r13* | 5.595 | 1.277 | | 1.58340 | 30.23 |
| r14 | ∞ | | | 1.58340 | 30.23 |

TABLE 6

| LENS | | | | | |
|---|---|---|---|---|---|
| SUR- | | ASPHERICITY COEFFICIENT | | | |
| FACE | k | A | B | C | D |
| r1 | 0 | −4.990E−04 | 7.038E−05 | −4.226E−06 | 1.533E−07 |
| r4 | 0 | −6.666E−04 | 4.654E−05 | 4.449E−04 | −1.555E−04 |
| r8 | 0 | −6.401E−03 | −7.899E−04 | 6.625E−05 | 9.459E−06 |
| r9 | 0 | −2.222E−03 | −1.643E−03 | 2.912E−04 | 1.433E−05 |
| r10 | 0 | 6.274E−03 | −2.387E−03 | −2.785E−05 | 4.771E−05 |
| r11 | 0 | 7.616E−03 | −1.158E−03 | −7.103E−04 | 1.077E−04 |
| r12 | 0 | −3.329E−03 | 2.475E−06 | 9.659E−06 | −2.790E−07 |
| r13 | 0 | −2.652E−03 | −2.525E−04 | 1.631E−05 | −3.022E−07 |

### EXAMPLE 3

Tables 7 and 8 represent construction data of the respective lenses in the image pickup optical system 53 according to the third embodiment (the example 3).

TABLE 7

| | | AXIAL SURFACE | | | |
|---|---|---|---|---|---|
| | | SEPARATION | | | |
| OPTICAL- | | INFINITY | VICINITY | | |
| SURFACE | RADIUS OF | FOCUSING | FOCUSING | REFRACTIVE | ABBE |
| NUMBER | CURVATURE | STATE | STATE | INDEX | NUMBER |
| | ∞ | ∞ | 500 | 1.53048 | 55.72 |
| r1* | −5.774 | 5.072 | | | |
| r2* | −4.181 | 1.000 | | | |
| r3 | ∞ | 1.880 | 1.483 | | |
| r4* | 4.406 | 1.300 | | 1.53048 | 55.72 |
| r5* | 5.943 | 0.256 | | | |
| r6* | −2.481 | 1.300 | | 1.58340 | 30.23 |
| r7* | −37.890 | 1.764 | 2.177 | | |
| r8* | 6.091 | 4.581 | | 1.53048 | 55.72 |
| r9* | 12.992 | 0.268 | | | |
| r10 | ∞ | 0.300 | | 1.51680 | 65.26 |
| r11 | ∞ | 0.500 | | | |
| r12 | ∞ | | | | |

TABLE 8

| LENS | | | | | |
|---|---|---|---|---|---|
| SUR- | | ASPHERICITY COEFFICIENT | | | |
| FACE | k | A | B | C | D |
| r1 | 0 | 1.853E−03 | −1.433E−05 | −3.034E−06 | 1.441E−07 |
| r2 | 0 | 0.709E−03 | −2.834E−04 | 2.061E−05 | −3.885E−07 |
| r4 | 0 | 1.190E−02 | −8.105E−04 | −1.480E−04 | 2.893E−05 |
| r5 | 0 | 1.226E−02 | 1.226E−03 | −2.531E−03 | 4.682E−04 |
| r6 | 0 | 3.977E−02 | −3.632E−04 | −1.855E−03 | 4.047E−04 |
| r7 | 0 | 2.062E−02 | 6.115E−04 | 2.407E−04 | −8.737E−06 |
| r8 | 0 | −3.634E−03 | 2.999E−04 | −7.055E−04 | −5.445E−08 |
| r9 | 0 | 1.913E−03 | −1.114E−03 | 1.113E−04 | −3.456E−06 |

### EXAMPLE 4

Table 9 and 10 represent construction data of the respective lenses in the image pickup optical system 54 according to the forth embodiment (the example 4).

TABLE 9

| | | AXIAL SURFACE | | | |
|---|---|---|---|---|---|
| | | SEPARATION | | | |
| OPTICAL- | | INFINITY | VICINITY | | |
| SURFACE | RADIUS OF | FOCUSING | FOCUSING | REFRACTIVE | ABBE |
| NUMBER | CURVATURE | STATE | STATE | INDEX | NUMBER |
| | ∞ | ∞ | 200 | | |
| r1 | ∞ | 0.000 | | | |
| r2* | 17.833 | 4.371 | | 1.58913 | 61.11 |
| r3* | −2.135 | 0.482 | 0.544 | | |
| r4* | −1.399 | 0.176 | | 1.58340 | 30.23 |
| r5* | −14.772 | 1.722 | 1.660 | | |
| r6* | 2.535 | 6.387 | | 1.53048 | 55.72 |
| r7* | 47.000 | 0.205 | | | |
| r8 | ∞ | 0.533 | | 1.51680 | 65.26 |
| r9 | ∞ | 0.280 | | | |
| r10 | ∞ | | | | |

TABLE 10

| LENS | | ASPHERICITY COEFFICIENT | | | | |
|---|---|---|---|---|---|---|
| SURFACE | k | A | B | C | D | E |
| r2 | −314.18159 | 3.075E−03 | 4.414E−03 | −8.388E−03 | 4.074E−03 | |
| r3 | −3.774837 | −8.217E−03 | −8.113E−03 | 1.411E−03 | 5.197E−03 | |
| r4 | −3.207117 | −8.561E−02 | 2.689E−03 | −1.388E−03 | −1.366E−03 | 1.940E−04 |
| r5 | 39.078736 | −4.528E−02 | 8.458E−03 | −8.667E−04 | 3.170E−05 | 4.181E−07 |
| r6 | −4.108197 | 2.180E−03 | −6.884E−04 | 6.605E−05 | −4.774E−06 | 1.244E−07 |
| r7 | −1.47498E+27 | 6.684E−03 | 1.328E−04 | −1.663E−04 | 1.858E−05 | −5.905E−07 |

### EXAMPLE 5

Tables 11 and 12 illustrate construction data of the respective lenses in the image pickup optical system 55 according to the fifth embodiment (the example 5).

TABLE 11

| | | AXIAL SURFACE | | | |
|---|---|---|---|---|---|
| | | SEPARATION | | | |
| OPTICAL- | | INFINITY | VICINITY | | |
| SURFACE | RADIUS OF | FOCUSING | FOCUSING | REFRACTIVE | ABBE |
| NUMBER | CURVATURE | STATE | STATE | INDEX | NUMBER |
| | ∞ | ∞ | 500 | | |
| r1* | −5.168 | 4.939 | | 1.58340 | 30.23 |
| r2* | −5193.156 | 0.100 | | | |
| r3 | ∞ | 0.822 | 0.743 | | |
| r4* | 2.852 | 3.000 | | 1.53048 | 55.72 |
| r5 | −2.753 | 0.240 | | 1.58340 | 30.23 |
| r6* | −16.022 | 3.073 | 3.171 | | |
| r7* | −15.591 | 5.003 | | 1.58340 | 30.23 |
| r8* | −54.952 | 0.100 | | | |
| r9 | ∞ | 0.300 | | 1.51680 | 65.26 |
| r10 | ∞ | 0.282 | | | |
| r11 | ∞ | | | | |

TABLE 12

| LENS | | ASPHERICITY COEFFICIENT | | | |
|---|---|---|---|---|---|
| SURFACE | k | A | B | C | D |
| r1 | −0.482825 | 2.38E−03 | −1.83E−04 | 3.60E−06 | −3.04E−06 |
| r2 | −0.87E+36 | −7.35E−03 | 2.77E−04 | 3.51E−04 | −7.26E−05 |
| r4 | −2.399317 | 4.51E−04 | 1.94E−04 | 1.46E−06 | −6.10E−06 |
| r6 | 5.340723 | −1.91E−03 | −2.39E−04 | −1.12E−06 | −2.36E−07 |
| r7 | 48.069031 | −9.07E−03 | −1.22E−04 | −2.87E−06 | −2.77E−05 |
| r8 | −4.09E+25 | −3.52E−03 | −7.01E−04 | 1.23E−04 | −6.10E−06 |

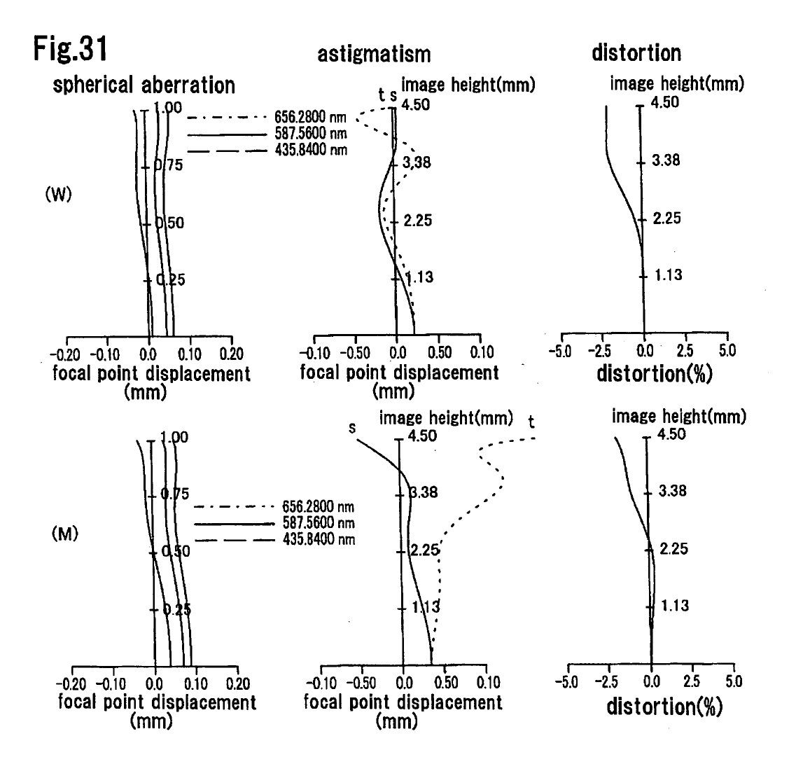

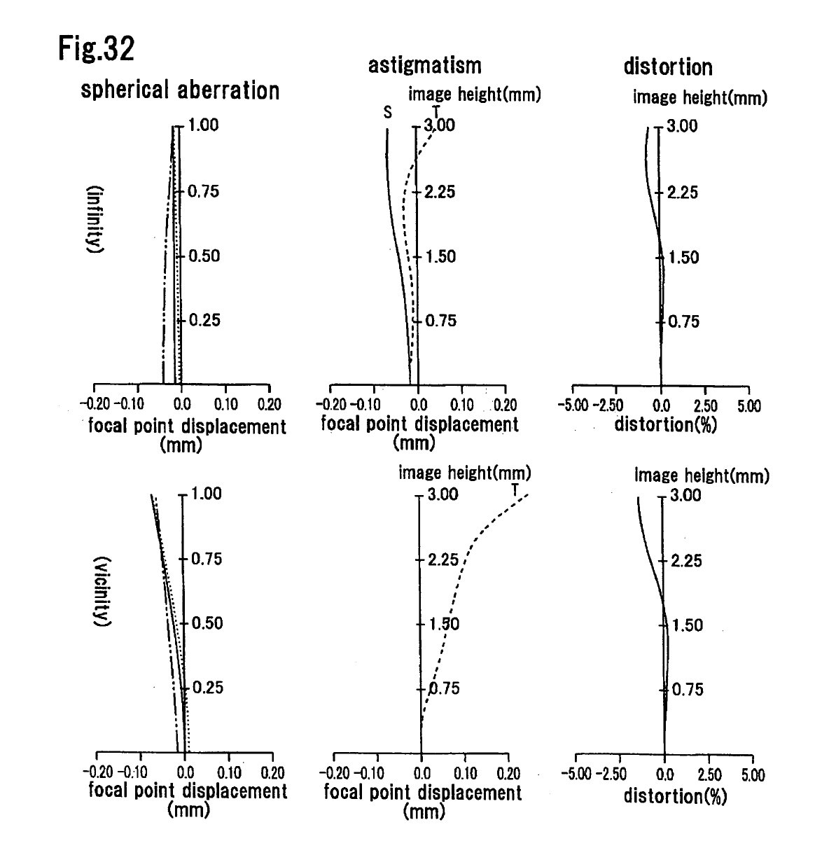

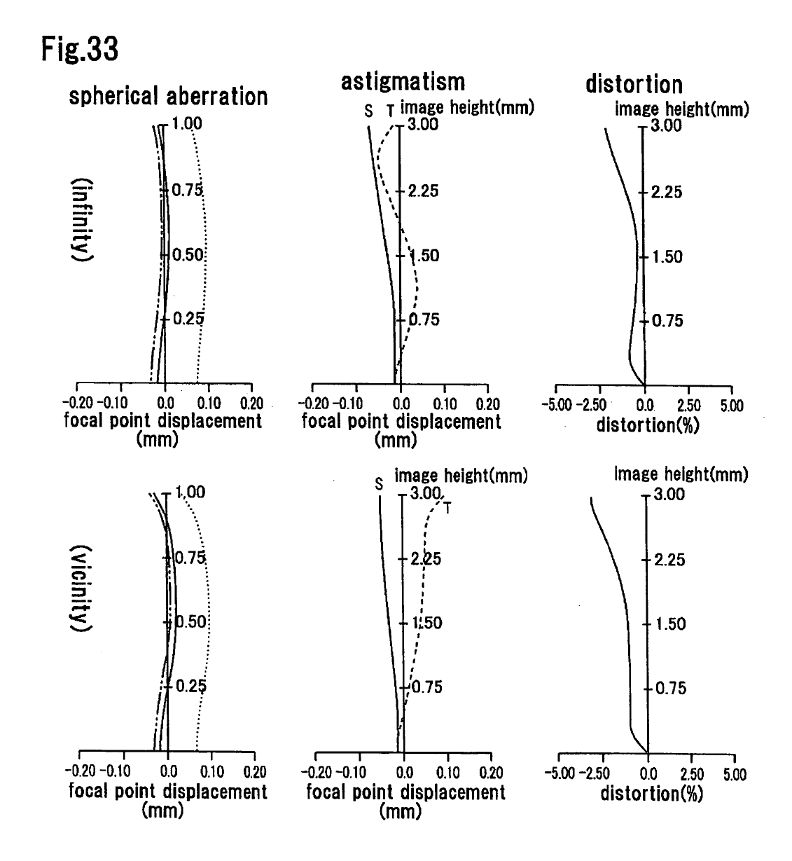

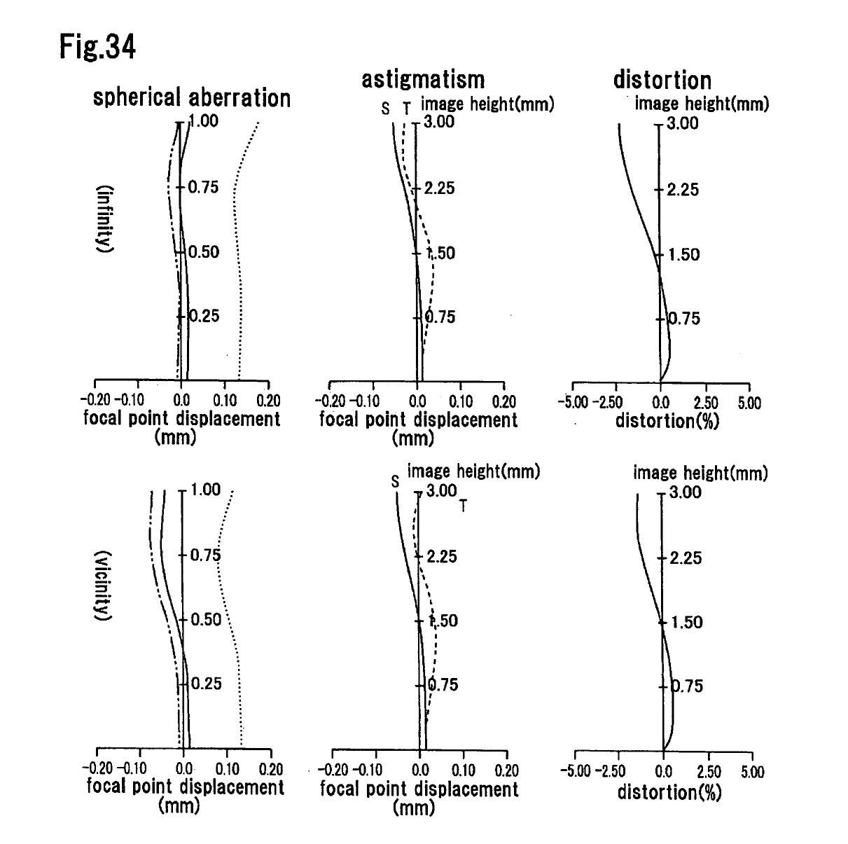

FIGS. 31 to 34 represent, in order from the left to the right, the spherical aberrations, the astigmatisms and the distortions of the entire optical systems according to the examples 2 to 5 having the aforementioned lens placement and structures. Any of the image pickup optical systems 52 to 55 according to the examples can sufficiently suppress the spherical aberration, the astigmatism and the distortion, at both the infinity focusing state and the vicinity focusing state, thereby exhibiting excellent optical characteristics. Table 13 illustrates the focal lengths (mm), the F values and the maximum image heights at the infinity focusing state, in the examples 2 to 5. These tables show that these examples can realize optical systems with excellent brightness, similarly to the example 1.

TABLE 13

| | FOCAL | | MAXIMUM IMAGE |
|---|---|---|---|
| | LENGTH (mm) | F VALUE | HEIGHT (mm) |
| EXAMPLE 1 | 7.96 | 4.0 | 4.5 |
| EXAMPLE 2 | 7.82 | 4.0 | 4.5 |
| EXAMPLE 3 | 6.82 | 3.5 | 3 |
| EXAMPLE 4 | 6.40 | 3.5 | 3 |
| EXAMPLE 5 | 6.40 | 3.0 | 3 |

[Detailed Description of Embodiments of Variable-Power Optical Systems]

Subsequently, with reference to the drawings, there will be described the concrete structure of the variable-power optical system 110 illustrated in FIG. 11, namely the variable-power optical system 110 constituting the image pickup apparatus 206 which is mounted in the camera-equipped cellular phone 200 or 300 or the portable information terminal device 400 illustrated in FIGS. 12 to 14.

### Sixth Embodiment

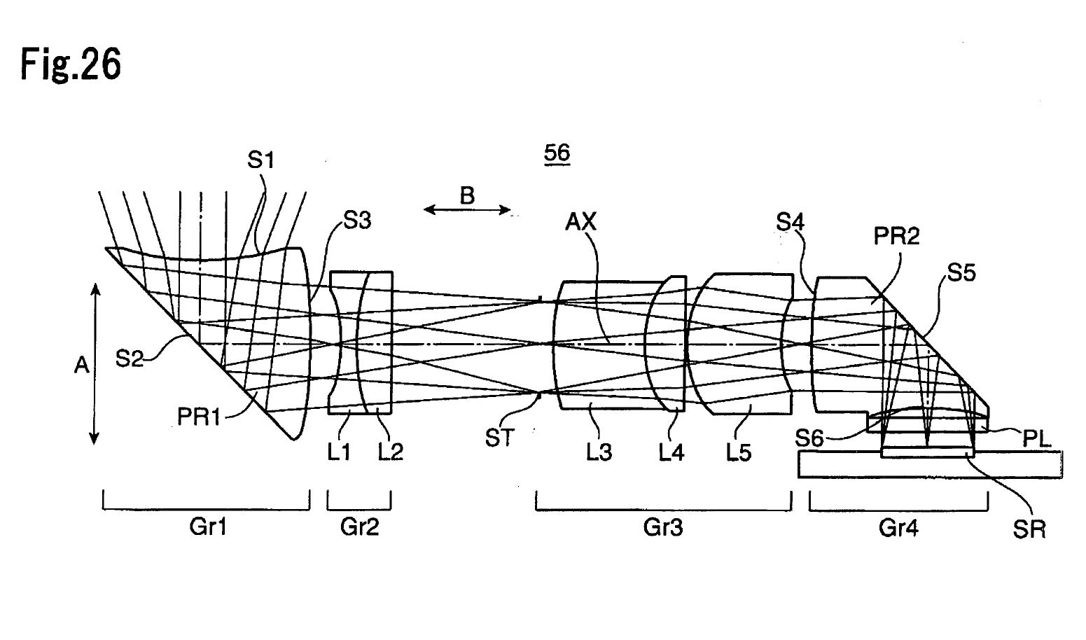

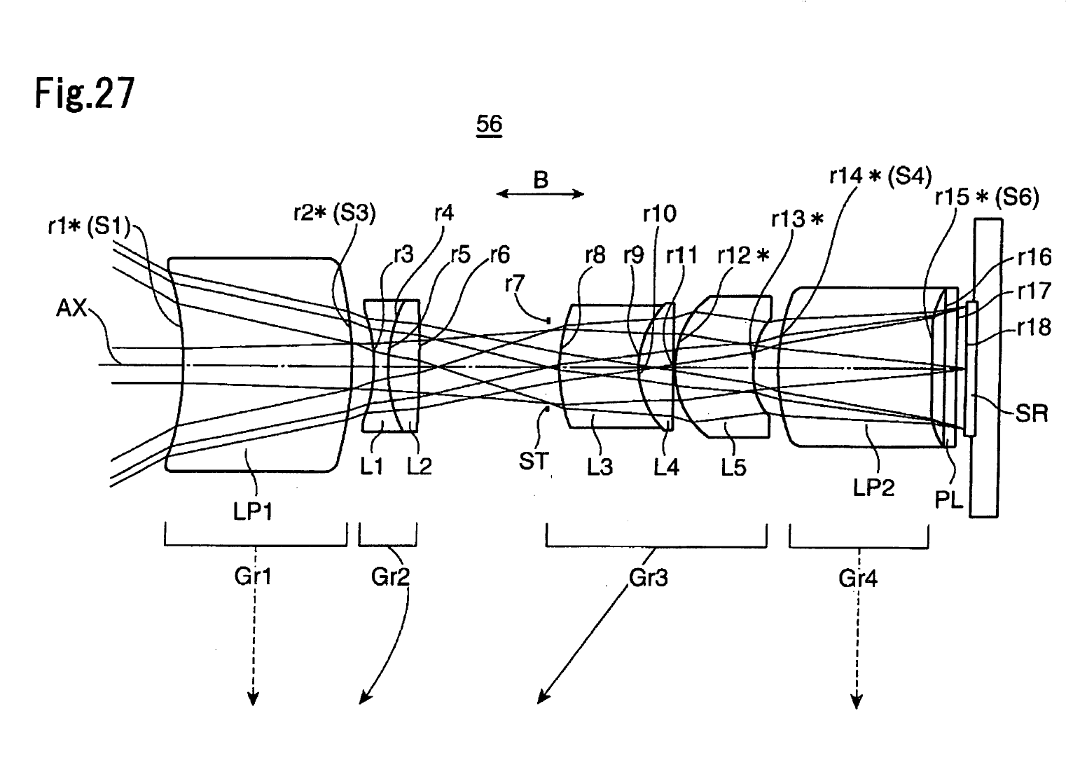

FIG. 26 is a longitudinal cross-sectional view illustrating the arrangement of lenses in a variable-power optical system 56 according to a sixth embodiment, taken along an optical axis (AX). FIG. 26 illustrates the placement of the optical devices at a state where they are focused at infinity. In FIG. 26 (and FIGS. 27 to 29), there is further illustrated the general outline of the path of light incident from the object-side (the optical path) and the center line of the optical path is the optical axis (AX).

The variable-power optical system 56 according to the present embodiment is structured to include, in order from the object-side along the optical path, a first group of lenses (Gr1) constituted by a first reflection prism (PR1; corresponding to the incidence-side prism 101 in FIG. 11) having negative optical power in its entirety, a second group of lenses (Gr2) constituted by a compound lens made of a double-concave negative lens (L1) (a lens having negative optical power) and a double-convex positive lens (a lens having positive optical power) (L2) and having negative optical power in its entirety, a third group of lenses (Gr3) constituted by a compound lens made of a negative meniscus lens (L3) having a convex surface at its object side and a fourth lens (L4) which is a double-convex positive lens and a positive meniscus lens (L5) having a convex surface at its object side, including an optical diaphragm (ST) and having positive optical power in its entirety, and a fourth group of lenses (Gr4) constituted by a second reflection prism (PR2; corresponding to the image-surface side prism 102 in FIG. 11) having positive optical power. In this case, the second and third groups of lenses (Gr2 and Gr3) are provided such that their optical axes are in coincident with the center line (AX) of the optical path between the aforementioned two reflection prisms (PR1 and PR2). Further, a plane parallel plate (PL) and an image pickup device (SR) are placed near the image-side of the second reflection prism (PR2). The image pickup device (SR) is an image pickup device having a length-to-width ratio of 3:4, for example.

The first reflection prism (PR1) has an incidence surface (S1) having negative optical power, an emission surface (S3) having positive optical power, and a flat-shaped reflection surface (S2) on the optical path between the incidence surface (S1) and the emission surface (S3). The second reflection prism (PR2) has an incidence surface (S4) having positive optical power, an emission surface (S6) having negative optical power and a flat-shaped reflection surface (S5) on the optical path between the incidence surface (S4) and the emission surface (S6). The reflection surfaces (S2 and S5) provided in the first reflection prism (PR1) and the second reflection prism (PR2) fold the incident light by about 90 degree and reflect it toward the second group of lenses (Gr2) or the plane parallel plate (PL), in the present embodiment.

FIG. 26 illustrates a variable-power optical system 56 structured to fold a light ray in the direction of the shorted sides of the image pickup device (SR). Namely, the horizontal (lateral) direction in FIG. 26 is the direction of the shorter sides of the image pickup device (SR). Namely, the direction of an arrow A corresponds to the thickness-wise direction of the cellular phone 200 illustrated in FIG. 12.

FIG. 27 is a view illustrating the structure of an image pickup optical system 56 structured by replacing the first reflection prism (PR1) and the second reflection prism (PR2) in FIG. 26 with lenses (LP1 and LP2) having functions substantially equal to those of the reflection prisms. The numbers ri (i=1, 2, 3, . . . ) illustrated in FIG. 27 designate i-th lens surfaces countered from the object side, and a mark of * attached to the numbers ri indicate an aspherical surface. Further, the number of the lenses constituting a compound lens designates the number of single lenses constituting the compound lens, and the entire compound lens is not regarded as a single lens. For example, the number of lenses in a compound lens constituted by three single lenses is designated as three, not one.

In the aforementioned structure, a light ray incident from the object-side in FIG. 26 enters the incidence surface (S1) of the first reflection prism (PR1), then is folded by about 90 degree by the reflection surface (S2), then is emitted from the emission surface (S3), then is passed through the second group of lenses (Gr2) and the third group of lenses (Gr3) and enters the incidence surface (S4) of the second reflection prism (PR2). Then, the incident light is folded by about 90 degree at the reflection surface (S5), then is emitted from the emission surface (S6) and forms an optical image thereat. The optical image is passed through the plane parallel plate (PL) placed adjacent to the second reflection prism (PR2). At this time, the optical image is modified in such a way as to minimize so-called folding noises caused by conversion of the optical image into electrical signals by the image pickup device (SR). The plane parallel plate (PL) corresponds to an optical low-pass filter, an infrared-radiation cutting filter, a cover glass on the image pickup device or the like.

Then, the image pickup device (SR) converts, into electrical signals, the optical image which has been modified by the plane parallel plate (PL). The electrical signals are subjected to predetermined digital image processing and image compression processing as required and are recorded as digital image signals in a memory in the cellular phone 200 or 300 or the portable information terminal device 400 illustrated in FIGS. 12 to 14 or transmitted to other digital apparatuses in wired or wireless communication.

Hereinafter, the intermediate point between the wide angle (W) having a smallest focal length, namely a greatest angle of view, and the telephoto end (T) having a greatest focal length, namely a smallest angle of view, will be referred to as an intermediate point (M).

In the lens structure according to the sixth embodiment as in FIG. 26, the first and second reflection prisms (PR1 and PR2) are secured, during power variation from the wide angle end (W) to the telephoto end (T) as illustrated in FIG. 27. Then, the second group of lenses (Gr2) is moved toward the object-side along a convex U-turn shape and becomes closest to the image-side at the intermediate point (M). Also, the third group of lenses (Gr3) is moved substantially straightly toward the object-side. At this time, the second group of lenses (Gr2) and the third group of lenses (Gr3) are both moved in the direction of the optical axis of these groups of lenses to perform a power-varying operation. However, the direction and the amount of movement of these groups of lenses can be varied depending on the optical powers and the like of these groups of lenses.

Further, in focusing from an infinity focusing state to a vicinity focusing state, the first and second prisms (PR1 and PR2) are secured and at least one of the second group of lenses (Gr2) and the third group of lenses (Gr3) is moved in the direction parallel to the optical axis (the arrow B in FIG. 26), which enables focusing without changing the total thickness (the direction of the arrow A in FIG. 26) and therefore is desirable.

### Seventh Embodiment

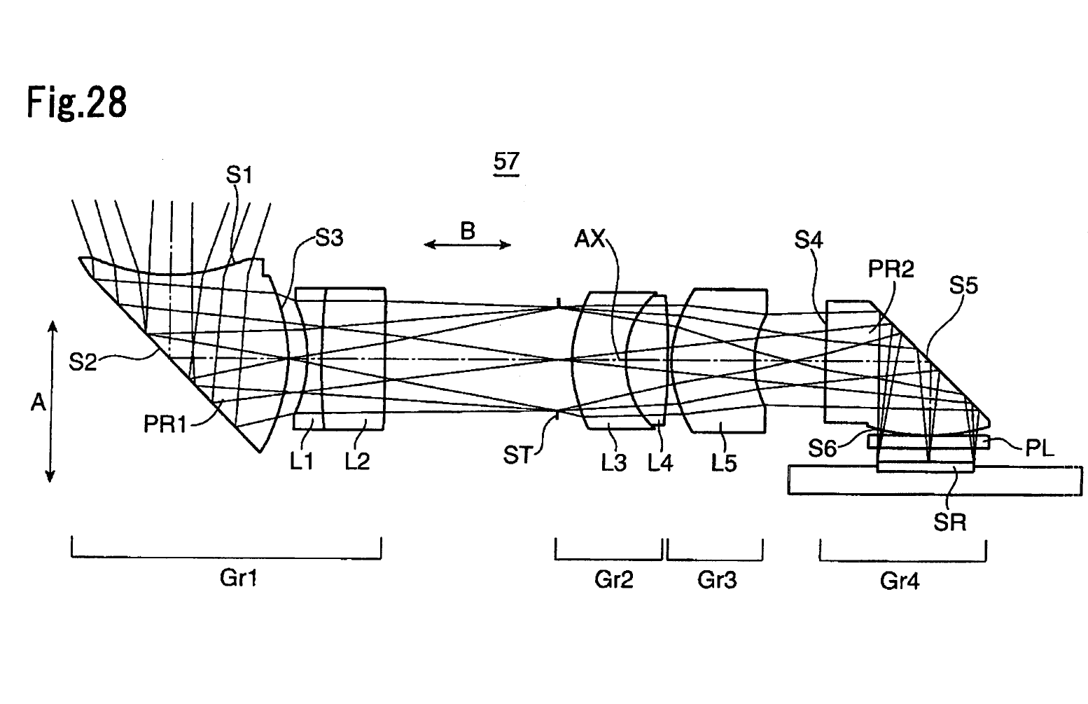

FIG. 28 is a longitudinal cross-sectional view illustrating the arrangement of lenses in a variable-power optical system 57 according to a seventh embodiment, taken along an optical axis (AX). FIG. 28 illustrates the placement of the optical devices at a state where they are focused at infinity.

The variable-power optical system 57 according to the present embodiment is structured to include, in order from the object-side along the optical path, a first group of lenses (Gr1) constituted by a first reflection prism (PR1) having negative optical power and a compound lens made of a double-concave negative lens (L1) and a double-convex positive lens (L2) and having negative optical power in its entirety, a second group of lenses (Gr2) constituted by a compound lens made of a negative meniscus lens (L3) having a convex surface at its object side and a double-convex positive lens (L4), having negative optical power in its entirety and including an optical diaphragm (ST), a third group of lenses (Gr3) constituted by a positive meniscus lens (L5) having a convex surface at its object side, and a fourth group of lenses (Gr4) constituted by a second reflection prism (PR2) having positive optical power. In this case, the second and third groups of lenses (Gr2 and Gr3) are provided such that their optical axes are in coincident with the center line (AX) of the optical path between the aforementioned two reflection prisms (PR1 and PR2). Further, a plane parallel plate (PL) and an image pickup device (SR) are placed near the image-side of the second reflection prism (PR2).

The first reflection prism (PR1) has an incidence surface (S1) having negative optical power, an emission surface (S3) having positive optical power, and a flat-shaped reflection surface (S2) on the optical path between the incidence surface (S1) and the emission surface (S3). The second reflection prism (PR2) has an incidence surface (S4) having positive optical power, an emission surface (S6) having positive optical power and a flat-shaped reflection surface (S5) on the optical path between the incidence surface (S4) and the emission surface (S5). The reflection surfaces (S2 and S5) provided in the first reflection prism (PR1) and the second reflection prism (PR2) fold the incident light by about 90 degree and reflect it toward the second group of lenses (Gr2) or the plane parallel plate (PL), in the present embodiment.

FIG. 28 illustrates a variable-power optical system 57 structured to fold a light ray in the direction of the shorted sides of the image pickup device (SR), similarly to in FIG. 26. The direction of an arrow A corresponds to the thickness-wise direction of the cellular phone 200 illustrated in FIG. 12.

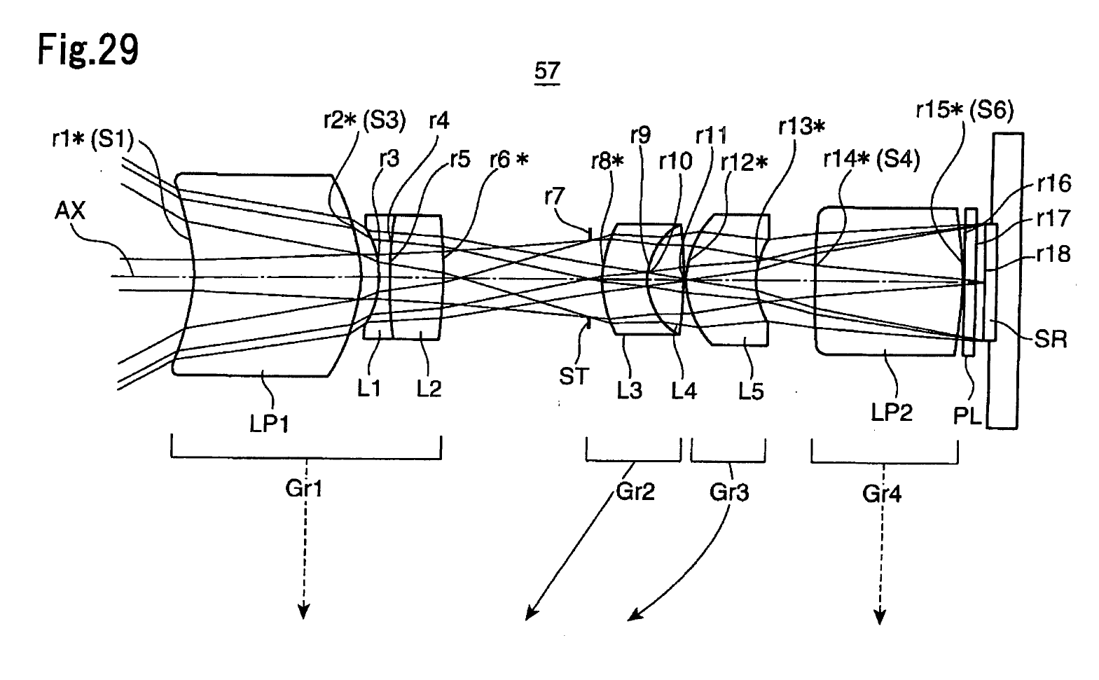

FIG. 29 is a view illustrating the structure of an image pickup optical system 57 structured by replacing the first reflection prism (PR1) and the second reflection prism (PR2) in FIG. 28 with lenses having functions substantially equal to those of the reflection prisms.

In the aforementioned structure, a light ray incident from the object-side in FIG. 28 is folded by about 90 degree at the reflection surface (S2) of the first reflection prism (PR1), then is passed through the second group of lenses (Gr2) and the third group of lenses (Gr3), then is folded by about 90 degree at the reflection surface (S5) of the second reflection prism (PR2) and forms an optical image of the object on the light receiving surface of the image pickup device (SR).

In the lens structure according to the seventh embodiment as in FIG. 28, the first and second reflection prisms (PR1 and PR2) are secured, during power variation from the wide angle end (W) to the telephoto end (T) as illustrated in FIG. 29. Then, the second group of lenses (Gr2) is moved substantially straightly toward the object-side, and the third group of lenses (Gr3) is also moved toward the object-side while changing the distance to the second group of lenses (Gr2). At this time, the second group of lenses (Gr2) and the third group of lenses (Gr3) are both moved in the direction of the optical axis of these groups of lenses to perform a power-varying operation.

Further, in focusing from an infinity focusing state to a vicinity focusing state, the first and second prisms (PR1 and PR2) are secured and at least one of the second group of lenses (Gr2) and the third group of lenses (Gr3) is moved in the direction parallel to the optical axis (the arrow B in FIG. 28), which enables focusing without changing the total thickness (the direction of the arrow A in FIG. 28) and therefore is desirable.

Hereinafter, the image pickup optical systems 56 to 57 according to the aforementioned sixth and seventh embodiments will be concretely described, by exemplifying construction (structure) data, aberration diagrams, and the like.

### EXAMPLE 6

Tables 14 and 15 illustrate construction data of the respective lenses in the image pickup optical system 56 according to the sixth embodiment (the example 6).

TABLE 14

| | | AXIAL SURFACE | | | | |
|---|---|---|---|---|---|---|
| | RADIUS OF | SEPARATION | | | | |
| OPTICAL- | CURVA- | (INFINITY | | | REFRAC- | |
| SURFACE | TURE | FOCUSING, mm) | | | TIVE | ABBE |
| NUMBER | (mm) | W | M | T | INDEX | NUMBER |
| | — | ∞ | ∞ | ∞ | | |
| r1* | −8.591 | 7.181 | | | 1.58340 | 30.23 |
| r2* | −16.102 | 1.019 | 1.826 | 0.656 | | |
| r3 | −5.670 | 0.574 | | | 1.67603 | 54.67 |
| r4 | 5.934 | 0.008 | | | 1.51400 | 42.83 |
| r5 | 5.934 | 1.336 | | | 1.84828 | 33.62 |
| r6 | −41.351 | 5.462 | 1.713 | 0.100 | | |
| r7 | | 0.574 | | | | |
| r8 | 8.031 | 3.400 | | | 1.84666 | 23.82 |
| r9 | 3.690 | 0.008 | | | 1.51400 | 42.83 |
| r10 | 3.690 | 1.488 | | | 1.64275 | 56.36 |
| r11 | −89.291 | 0.100 | | | | |
| r12* | 3.741 | 3.393 | | | 1.51342 | 66.94 |
| r13* | 4.610 | 1.076 | 3.861 | 6.645 | | |
| r14* | 11.242 | 6.468 | | | 1.51680 | 64.20 |
| r15* | −25.187 | 0.483 | | | | |
| r16 | ∞ | 0.500 | | | 1.51680 | 64.20 |
| r17 | ∞ | 0.500 | | | | |
| r18 | ∞ | | | | | |

TABLE 15

| LENS | | ASPHERICITY COEFFICIENT | | | | |
|---|---|---|---|---|---|---|
| SURFACE | k | A | B | C | D | E |
| r1 | 0.098636 | 1.39E−03 | −3.05E−05 | 1.65E−06 | −5.70E−08 | 8.64E−10 |
| r2 | 0 | 7.89E−04 | −5.99E−05 | 8.21E−06 | −4.19E−07 | 0.00E+00 |
| r12 | 0 | 2.59E−04 | −9.52E−05 | 1.55E−05 | −1.26E−06 | 0.00E+00 |
| r13 | 0 | 6.42E−03 | 1.61E−04 | 4.99E−05 | 6.34E−06 | 0.00E+00 |
| r14 | 0 | 1.62E−03 | −1.07E−04 | 1.34E−05 | −5.19E−07 | 0.00E+00 |
| r15 | 0 | 7.00E−03 | −3.18E−05 | −5.79E−05 | 5.71E−06 | 0.00E+00 |

FIG. 14 illustrates the respective lens-surface numbers, the radiuses of curvature of the respective surfaces (with a unit of mm), the respective intervals between adjacent lens surfaces along the optical axis at an infinity focusing state in the wide angle (W), the intermediate point (M) and the telephoto end (T) (the axial surface separations) (with a unit of mm), the refractive indexes and the Abbe numbers of the respective lenses, in the mentioned order from the light to the left. The blanks in the fields of the axial surface separations M and T indicate the same values as those in the field of the axial surface separation W at the left thereof. The axial surface separations are distances converted on the assumption that air exists through the space between each pair of opposing surfaces (including optical surfaces and the image pickup surface) as a medium. In this case, the respective lens-surface numbers ri (i=1, 2, 3, . . . ) designate the i-th lens surfaces counted from the object-side, as illustrated in FIG. 27, wherein a mark of * attached to the numbers ri indicates aspherical surfaces (refractive optical surfaces having aspherical shapes or surfaces having refracting effects equivalent to those of aspherical surfaces).

As can be seen from Table 14, in the present example 4, the lens (LP1) closest to the object-side, the fifth lens (L5) and the lens (LP2) closest to the image-side have aspherical surfaces at their opposite sides. Further, the optical diaphragm (ST) and the plane parallel plate (PL) have flat surfaces at their opposite sides, and the image pickup device (SR) also has a flat surface at its light receiving surface, and these flat surfaces have radiuses of curvature of infinity.

The aspherical shapes of the optical surfaces are defined by the following equation (5) which uses a local rectangular coordinate system (x, y, z), wherein the vertexes of the surfaces are placed on the origin and the direction from the object to the image pickup device is set to the positive direction along the z axis.

$$\begin{matrix}[ Equation 3 ] & \\ Z = \frac{c \cdot {h}^{2}}{1 + \sqrt{1 - ( 1 + k ) {c}^{2} \cdot {h}^{2}}} + A \cdot {h}^{4} + B \cdot {h}^{6} + C \cdot {h}^{8} + D \cdot {h}^{10} + E \cdot {h}^{12} & ( 5 )\end{matrix}$$

z: the amount of displacement at a height h in the direction of z axis (with respect to the vertex of the surface)

h: the height in the direction perpendicular to the z axis (h2=x2+y2)

c: the paraxial curvature (1/the radius-of-curvature)

A, B, C, D and E: quartic, sextic, octic, decadic and dodeca asphericity coefficients, respectively

k: the constant of the cone

Table 10 represents the values of the constant of the cone k and the asphericity coefficients A, B, C, D and E. As can be seen from the aforementioned equation (5), the radiuses of curvature of the aspherical lenses illustrated in Table 14 represent the values of the radiuses of curvature at the portions of the lenses near their surface-vortexes.

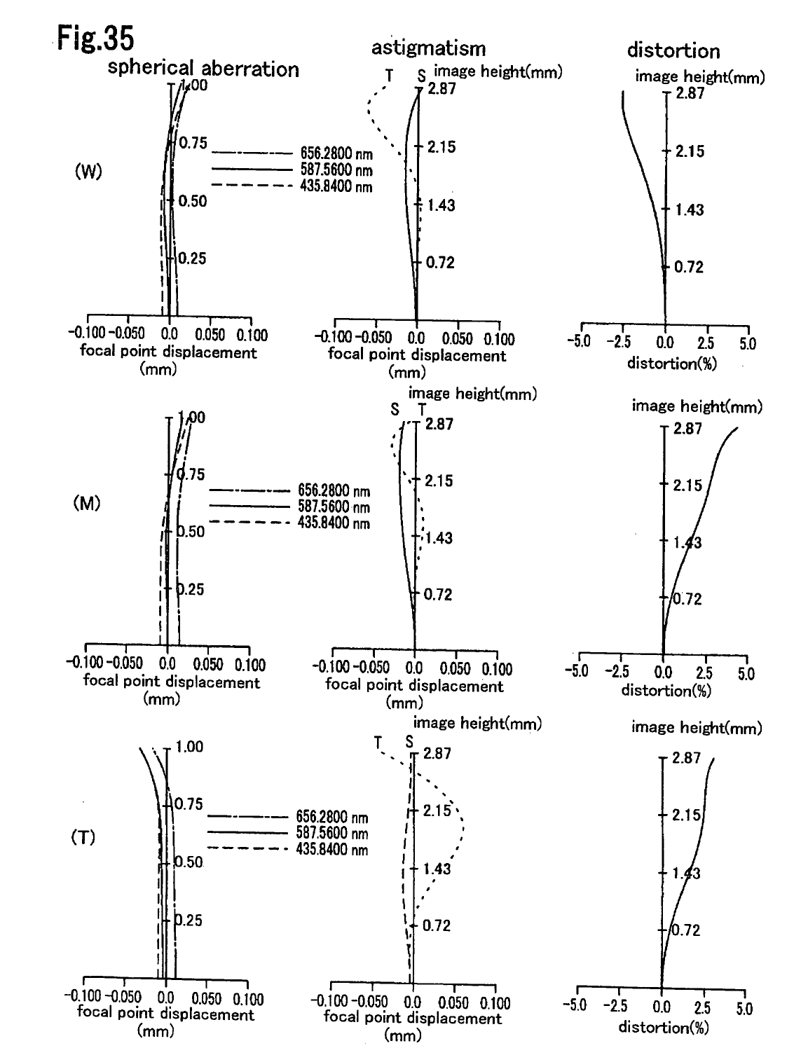

FIG. 35 illustrates, in order from the left to the right, the spherical aberration, the astigmatism and the distortion of the entire optical system according to the present example 6 (the combination of the first, the second, the third and the fourth groups of lenses) having the aforementioned lens placement and structure, at an infinity focusing state. In the figure, there are illustrated the spherical aberrations, the astigmatisms and the distortions at the wide angle (W), the intermediate point (M) and the telephoto end (T), in the upper state, the center stage and the lower stage, respectively. Further, the horizontal axes for the spherical aberration and the astigmatism represent the deviation of the focus point with a unit of mm. The horizontal axis for the distortion represents the distortion with respect to the entirety with a unit of %. The vertical axis for the spherical aberration represents values standardized with the incidence height, while the vertical axes for the astigmatism and the distortion represent the heights of images (the image height, with a unit of mm).

Further, in the diagrams of the spherical aberration, there are represented the aberrations for three lights with different wavelengths, wherein a chain line represents the aberration for a red light (with a wavelength of 656.27 nm), a solid line represents the aberration for an yellow light (so-called d line; with a wavelength of 587.56 nm) and a broken line represents the aberration for a blue light (with a wavelength of 435.83 nm). Further, in the diagrams of the astigmatism, reference characters of S and T represent results from sagital (radial) surfaces and tangential (meridional) surfaces, respectively. Further, the diagrams of the astigmatism and the distortion represent results obtained by using the aforementioned yellow light (d line).

As can be seen from FIG. 35, the groups of lenses in the present example 4 can sufficiently suppress the spherical aberration, the astigmatism and the distortion, at any of the wide angle (W), the intermediate point (M) and the telephoto end (T), thereby exhibiting excellent optical characteristics. Tables 18 and 19 represent the focal lengths (with a unit of mm) and the F values at the wide angle (W), the intermediate point (M) and the telephoto end (T) in the present example 4. These tables show that the present invention can realize short-focus optical systems with excellent brightness.

### EXAMPLE 7

Tables 16 and 17 illustrate construction data of the respective lenses in the variable-power image pickup optical system 57 according to the seventh embodiment (the example 7). As can be seen from these tables, in the example 7, the opposite surfaces of the lens (LP1) closest to the object-side, the image-side surface of the second lens (L2), the object-side surface of the third lens (L3), the opposite surfaces of the fifth lens (L5) and the opposite surfaces of the lens (LP2) closest to the image-side are aspherical surfaces.

TABLE 16

| | | AXIAL SURFACE | | | | |
|---|---|---|---|---|---|---|
| | RADIUS OF | SEPARATION | | | | |
| OPTICAL- | CURVA- | (INFINITY | | | REFRAC- | |
| SURFACE | TURE | FOCUSING, mm) | | | TIVE | ABBE |
| NUMBER | (mm) | W | M | T | INDEX | NUMBER |
| | — | ∞ | ∞ | ∞ | | |
| r1* | −6.031 | 7.424 | | | 1.58340 | 30.23 |
| r2* | −5.498 | 0.741 | | | | |
| r3 | −4.923 | 0.574 | | | 1.72858 | 52.48 |
| r4 | 29.654 | 0.008 | | | 1.51400 | 42.83 |
| r5 | 29.654 | 2.347 | | | 1.84666 | 23.82 |
| r6* | −51.572 | 6.596 | 2.807 | 0.100 | | |
| r7 | ∞ | 0.574 | | | | |
| r8* | 5.564 | 2.000 | | | 1.84666 | 23.82 |
| r9 | 3.201 | 0.008 | | | 1.51400 | 42.83 |
| r10 | 3.201 | 1.627 | | | 1.51389 | 66.89 |
| r11 | −21.826 | 0.100 | 1.840 | 0.791 | | |
| r12* | 4.500 | 3.200 | | | 1.51680 | 64.20 |
| r13* | 5.154 | 2.587 | 4.637 | 8.393 | | |
| r14* | 96.914 | 6.583 | | | 1.51680 | 64.20 |
| r15* | −6.517 | 0.000 | | | | |
| r16 | ∞ | 0.500 | | | 1.51680 | 64.20 |
| r17 | ∞ | 0.500 | | | | |
| r18 | ∞ | | | | | |

TABLE 17

| LENS | | ASPHERICITY COEFFICIENT | | | | |
|---|---|---|---|---|---|---|
| SURFACE | k | A | B | C | D | E |
| r1 | −0.599782 | 2.00E−03 | −1.02E−05 | −1.49E−06 | 7.60E−08 | −1.42E−09 |
| r2 | 0 | 2.27E−03 | −5.45E−07 | −2.58E−06 | 2.51E−08 | 0.00E+00 |
| r6 | 0 | −9.01E−04 | 2.65E−05 | −8.48E−07 | 1.81E−07 | 0.00E+00 |
| r8 | 0 | −7.51E−05 | 5.04E−05 | −1.29E−05 | 1.38E−06 | 0.00E+00 |
| r12 | 0 | 6.51E−04 | −8.51E−05 | 2.54E−05 | −1.64E−06 | 0.00E+00 |
| r13 | 0 | 4.58E−03 | −8.90E−05 | 8.22E−05 | −3.64E−06 | 0.00E+00 |
| r14 | 0 | 2.85E−04 | 1.10E−04 | −2.29E−05 | 1.52E−06 | 0.00E+00 |
| r15 | 0 | 9.83E−03 | −8.55E−04 | 4.91E−05 | −1.20E−06 | 0.00E+00 |

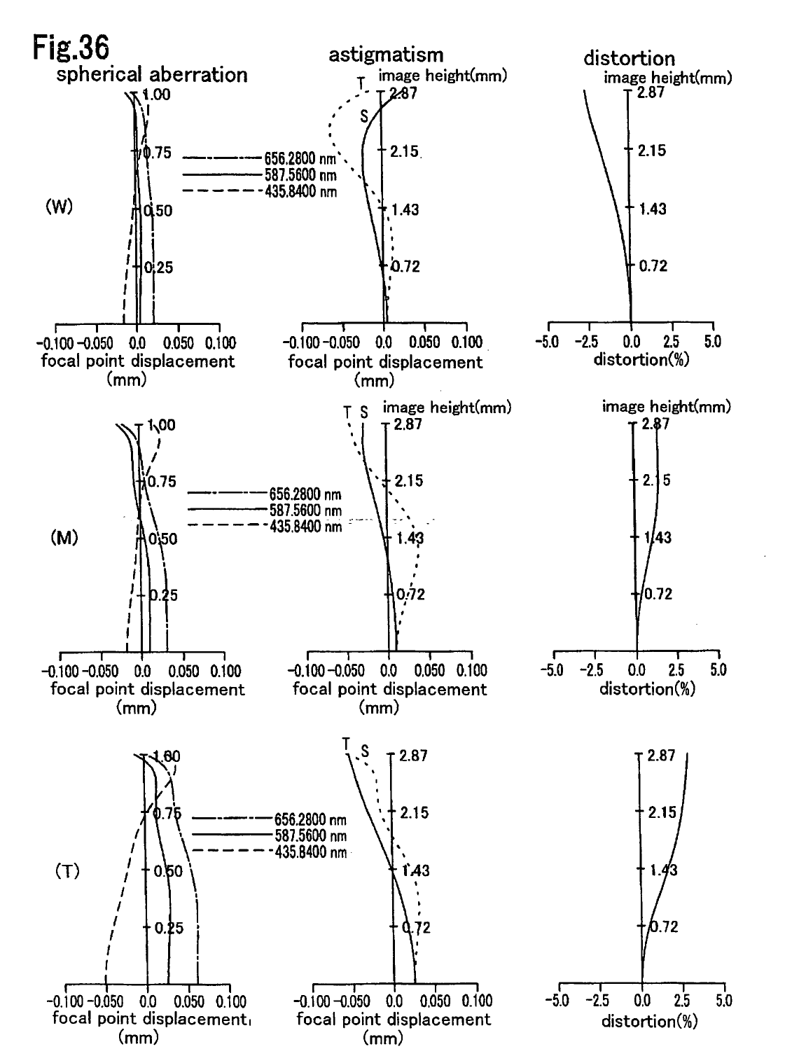

FIG. 36 illustrates the spherical aberration, the astigmatism and the distortion of the entire optical system according to the present example 7 having the aforementioned lens placement and structure, at an infinity focusing state. The groups of lenses in the present example 7 can also sufficiently suppress the spherical aberration, the astigmatism and the distortion, at any of the wide angle (W), the intermediate point (M) and the telephoto end (T), thereby exhibiting excellent optical characteristics.

Tables 18 and 19 represent the focal lengths (mm) and the F values at the wide angle (W), the intermediate point (M) and the telephoto end (T) in the present example 7. These tables show that the present invention can realize optical systems with excellent brightness, similarly to the example 6.

TABLE 18
FOCAL LENGTH (mm)

| | W | M | T |
|---|---|---|---|
| EXAMPLE 6 | 4.9 | 7.4 | 9.8 |
| EXAMPLE 7 | 4.9 | 7.4 | 10.8 |

TABLE 19
F value

| | W | M | T |
|---|---|---|---|
| EXAMPLE 6 | 3.1 | 3.8 | 4.5 |
| EXAMPLE 7 | 3.3 | 4.0 | 5.0 |

Table 20 represents the relationship between the radius of curvature CR of the emission surface (S3) of the incidence-side prism (PR1) and the physical length L of a light ray along the optical axis between the incidence surface (S1) and the emission surface (S3) of the incidence-side prism 101 (refer to the aforementioned equation (1)), in the aforementioned examples 1 to 7.

TABLE 20

| EXAMPLE | CR | L | CR/L |
|---|---|---|---|
| 1 | −6.442 | 4.312 | −1.49 |
| 2 | −12.695 | 4.474 | −2.84 |
| 3 | −4.181 | 5.072 | −0.824 |
| 4 | −2.135 | 4.371 | −0.488 |
| 5 | −5193.156 | 4.939 | −1050 |
| 6 | −16.102 | 7.181 | −2.24 |
| 7 | −5.498 | 7.424 | −0.741 |

As described above, in the image pickup optical systems 51 (51A and 51B) to 55 and the variable-power optical systems 56 and 57 according to the aforementioned first to seventh embodiments, the first reflection prism (PR1) is formed to have a convex emission surface (S3), which can reduce the amount of the unnecessary light beams (stray light) reflected by the emission surface (S3) and also causes the unnecessary light beams reflected by the emission surface (S3) and the reflection surface (S2) to be diffused, thereby significantly reducing the amount of unnecessary light beams directed to the light receiving surface of the image pickup device (SR). This enables suppressing the degradation of image quality due to unnecessary light beams while compacting the image pickup optical systems 51 (51A and 51B) to 55 and the variable-power optical systems 56 and 57.

Further, the image pickup optical systems 51 (51A and 51B) to 55 and the variable-power optical systems 56 and 57 have small sizes and weights and, therefore, can be suitably mounted on digital apparatuses, particularly on portable apparatuses such as cellular phones 200. Further, the image pickup optical systems and the variable-power optical systems can exhibit excellent optical performance applicable to high-pixel image pickup devices (image pickup devices in 2000000-pixel or more classes) and thus provide advantages over electronic zooming systems requiring interpolation.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. An imaging pickup optical system comprising:
a reflection prism for reflecting incident light by about 90 degree;
wherein the reflection prism has a convex-shaped emission surface.

2. The imaging pickup optical system of claim 1, wherein
the reflection prism satisfies the following formula
1<|CR|<20
CR: radius of curvature of the emission surface.

3. The imaging pickup optical system of claim 1, wherein
the reflection prism satisfies the following formula
−10<CR/L<−0.3
CR: radius of curvature of emission surface
L: physical length of on-axis principal ray from the incidence surface of the reflection prism to the emission surface thereof.

4. The imaging pickup optical system of claim 3, wherein
the reflection prism satisfies the following formula
−5<CR/L<−0.5.

5. The imaging pickup optical system of claim 1, wherein
the reflection prism is placed at a position closest to the object and has a concave-shaped incidence surface.

6. The imaging pickup optical system of claim 1, wherein
the optical system includes plural reflection prisms, and
wherein the reflection prisms are placed such that the incidence surface of the reflection prism placed near the object on the optical path and the emission surface of the reflection prism placed near the imaging device are substantially parallel to each other.

7. The imaging pickup optical system of claim 6, wherein
the reflection prism placed closest to the image surface on the optical axis has a concave-shaped incidence surface.

8. The imaging pickup optical system of claim 6, wherein
the imaging device satisfies the following formula
0.0≦d/a<1.0
d: physical length between the emission surface of the reflection prism placed near the image surface and the light receiving surface of the imaging device
a: image height of the light receiving surface.

9. The imaging pickup optical system of claim 6, wherein
the reflection prisms are formed from components made of a plastic material and inorganic particles dispersed therein.

10. The imaging pickup optical system of claim 1, wherein
the emission surface of the reflection prism is aspherical.

11. The imaging pickup optical system of claim 10, wherein
the reflection prism satisfies the following formula
−10<CR/L<−0.3
CR: radius of curvature of emission surface
L: physical length of on-axis principal ray along the axis from the incidence surface of the reflection prism to the emission surface thereof.

12. The imaging pickup optical system of claim 10, wherein
the reflection prism is placed at closest to the object and has a concave-shaped incidence surface.

13. The imaging pickup optical system of claim 1, wherein
the reflection prisms are formed from components made of a plastic material and inorganic particles dispersed therein.

14. The imaging pickup optical system of claim 13, wherein
the optical system includes plural reflection prisms for reflecting incidence light;
wherein the reflection prisms are placed such that the incidence surface of the reflection prism placed near the object on the optical path and the emission surface of the reflection prism placed near the imaging device are substantially parallel to each other.

15. The image pickup apparatus comprising:
an imaging pickup optical system which has reflection prisms for reflecting incident light while reflecting it by about 90 degree and has a convex-shaped emission surface; and
a imaging device,
wherein the imaging pickup optical system forms optical images of an object on the imaging device.

16. The image pickup apparatus of claim 15, wherein
the reflection prism is placed closest to the object and has a concave-shaped incidence surface.

17. The image pickup apparatus of claim 15, wherein
the optical system includes plural reflection prisms for reflecting incidence light, and
wherein the reflection prisms are placed such that the incidence surface of the reflection prism placed near the object on the optical path and the emission surface of the reflection prism placed near the image pickup device are substantially parallel to each other.

18. The image pickup apparatus of claim 15, wherein
the optical system includes plural reflection prisms for reflecting incidence light and also includes lenses movable in the direction of the optical axis which are placed between reflection prisms.

19. The digital apparatus comprising:
an imaging pickup optical system which has reflection prisms for reflecting incident light while reflecting it by about 90 degree and has a convex-shaped emission surface; and
a imaging device,
wherein the imaging pickup optical system forms optical images of an object on the imaging device.

20. The digital apparatus of claim 19, wherein
the apparatus has a control portion for controlling the capturing of still images of the object and the capturing of moving images of the object.
